(19) United States
(12) Patent Application Publication
(10) Pub. No.: US 2024/0214216 A1
(43) Pub. Date: Jun. 27, 2024

(54) INFORMATION PROCESSING APPARATUS AND METHOD, AND PROGRAM

(71) Applicant: Sony Group Corporation, Tokyo (JP)

(72) Inventors: Yoshiyuki KOBAYASHI, Tokyo (JP); Tatsuya IGARASHI, Tokyo (JP)

(73) Assignee: Sony Group Corporation, Tokyo (JP)

(21) Appl. No.: 18/287,266

(22) PCT Filed: Feb. 3, 2022
(86) PCT No.: PCT/JP2022/004217

§ 371 Date: Oct. 17, 2023

(30) Foreign Application Priority Data
May 25, 2021 (JP) 2021-087316

(51) Int. Cl. H04L 9/32

(52) U.S. Cl. CPC H04L 9/3247

(57) ABSTRACT

There is provided an information processing apparatus and method and a program enabling to ensure authenticity of a video image. The information processing apparatus includes: a signature generation unit configured to generate a first signature for every frame, on the basis of identification information, the frame of a video image, and a first private key of public key cryptosystem, the identification information being assigned to a time-block including a plurality of the frames of the video image; a certificate generation unit configured to generate a certificate including the identification information; and an output unit configured to output the certificate, the video image, and the first signature. The present technology can be applied to a transcoder.

### TECHNICAL FIELD

The present technology relates to an information processing apparatus and method and a program, and particularly relates to an information processing apparatus and method and a program capable of ensuring authenticity of a video image.

### BACKGROUND ART

For example, technology for ensuring that a video image captured and transmitted by a camera, that is, continuous still images, are not falsified on a communication path has been proposed.

In such technology, an electronic signature by public key cryptosystem is generated for each frame of the video image by the camera itself, and the electronic signature is verified for every frame by a recipient of the video image.

For example, many systems for generating and verifying the signature by the common key cryptosystem have been proposed, but such systems are not practical because it is necessary to securely share a common key between parties in advance.

Therefore, technology of a system for generating and verifying the signature by public key cryptosystem has been proposed (see, for example, Patent Document 1).

For example, as the system for generating and verifying the signature by public key cryptosystem, a combination of a hash function and public key cryptosystem has also been proposed.

Specifically, digital data M is compressed by a hash function H on a transmission side, and an output h having a certain length obtained as a result is encrypted by an encryption key (private key) Ke to obtain digital signature data s. Then, the digital data M and the digital signature data s are output as a set.

Furthermore, on the reception side, when the digital data M and the digital signature data s are received, the digital signature data s is decrypted with a decryption key (public key) Kd corresponding to the encryption key (private key) Ke, and an output h″ is generated. Moreover, the digital data M is compressed by using the hash function H to obtain an output h′, and the obtained output h′ and the output h″ are compared.

Then, in a case where the output h′ and the output h″ match, the digital data M is determined to be valid data that has not been subjected to invalid processing. In a case where the output h′ and the output h″ do not match, the digital data M is regarded as data subjected to invalid processing.

In the above example, correction, falsification, forgery, synthesis, and the like of the digital data M are detected using the digital signature data s generated by using the hash function H and the encryption key (private key) Ke.

### CITATION LIST

### Patent Document

Patent Document 1: Japanese Patent No. 4261724

### SUMMARY OF THE INVENTION

### Problems to be Solved by the Invention

However, in the above-described technology, it has not been able to say that authenticity of the video image is sufficiently ensured.

For example, in the above-described technology, generation and verification of the signature are performed on a frame basis. Therefore, in a case where falsification such as frame removal or frame order change of the video image is performed, such falsification cannot be detected.

The present technology has been made in view of such a situation, and is intended to be able to ensure authenticity of a video image.

### Solutions to Problems

An information processing apparatus according to a first aspect of the present technology includes: a signature generation unit configured to generate a first signature for every frame, on the basis of identification information, the frame of a video image, and a first private key of public key cryptosystem, the identification information being assigned to a time-block including a plurality of the frames of the video image; a certificate generation unit configured to generate a certificate including the identification information; and an output unit configured to output the certificate, the video image, and the first signature.

An information processing method or program according to the first aspect of the present technology is an information processing method or program corresponding to the information processing apparatus according to the first aspect of the present technology.

In the first aspect of the present technology, a first signature is generated for every frame, on the basis of identification information, the frame of a video image, and a first private key of public key cryptosystem, in which the identification information is assigned to a time-block including a plurality of the frames of the video image. Further, a certificate including the identification information is generated, and the certificate, the video image, and the first signature are output.

An information processing apparatus according to a second aspect of the present technology includes: an acquisition unit configured to acquire a certificate for every time-block, a video image, and a first signature for every frame, the certificate including identification information assigned to the time-block including a plurality of the frames of the video image, and the first signature being generated on the basis of the identification information, the frame of the video image, a first public key corresponding to a first private key of public key cryptosystem, and the first private key; and a signature verification unit configured to verify the first signature on the basis of the certificate, the video image, and the first public key.

An information processing method or program according to the second aspect of the present technology is an information processing method or program corresponding to the information processing apparatus according to the second aspect of the present technology.

In the second aspect of the present technology, a certificate for every time-block, a video image, and a first signature for every frame are acquired, in which the certificate includes identification information assigned to the time-block including a plurality of the frames of the video image. The first signature is generated on the basis of the identification information, the frame of the video image, a first public key corresponding to a first private key of public key cryptosystem, and the first private key. The first signature is verified on the basis of the certificate, the video image, and the first public key.

### BRIEF DESCRIPTION OF DRAWINGS

FIG. 1 is a view illustrating an output example of a video image of a camera in a verification technique 1.

FIG. 2 is a view illustrating an output example of a video image of the camera in a verification technique 2.

FIG. 3 is a view illustrating an output example of a video image of a transcoder in the verification technique 2.

FIG. 4 is a view illustrating an output example of a video image of the camera in a verification technique 3.

FIG. 5 is a view illustrating an output example of a video image of the transcoder in the verification technique 3.

FIG. 6 is a diagram illustrating a configuration example of a video image distribution system.

FIG. 7 is a diagram illustrating a configuration example of the camera.

FIG. 8 is a flowchart illustrating video image output processing.

FIG. 9 is a diagram illustrating a configuration example of the transcoder.

FIG. 10 is a flowchart for explaining verification processing.

FIG. 11 is a flowchart illustrating the video image output processing.

FIG. 12 is a diagram illustrating a configuration example of a client.

FIG. 13 is a flowchart for explaining the verification processing.

FIG. 14 is a view illustrating a configuration example of a computer.

### MODE FOR CARRYING OUT THE INVENTION

Hereinafter, an embodiment to which the present technology is applied will be described with reference to the drawings.

### First Embodiment

### <Verification Technique 1>

The present technology is for ensuring that, for example, a video image (continuous still images) captured and transmitted by a camera is not falsified on a communication path. That is, the present technology makes it possible to ensure authenticity of a video image captured and transmitted by a camera.

For example, in a news camera, a security camera, or the like, it is important to be able to identify which camera has captured a video image, and to ensure that the video image transmitted from the camera or the like has not been falsified, that is, to ensure authenticity of the video image.

Therefore, in the present technology, by using an identifier for every time-block of the video image, it has made possible to detect falsification such as frame removal and frame order change, and it has made possible to ensure the authenticity of the video image. In particular, the present technology relates to a generation system of an electronic signature and a public key certificate enabling to track an original video image even in a case of transcoding the video image on a communication path and transmitting the video image to a client.

Hereinafter, the present technology will be described specifically.

For example, in order to ensure authenticity of a video image captured and transmitted by a camera, it is assumed that the camera adds an electronic signature (hereinafter, also simply referred to as a signature) for every frame to the video image, and transmits the video image. In this case, a recipient of the video image can verify authenticity on a frame basis by verifying the electronic signature for every frame (hereinafter, also referred to as a video image frame) of the received video image.

Specifically, for example, an i-th frame from a head of the video image is defined as Frame [i].

At this time, for example, a message m [i] is obtained by obtaining a hash value of Frame [i] by using a secure hash algorithm 256 bit (SHA-256) function (hereinafter, also simply referred to as a hash function SHA-256) which is a hash function as shown in Equation (1) below.

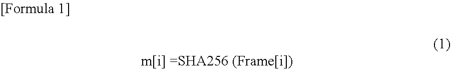

Furthermore, Equation (2) below is calculated on the basis of the message m [i] and a private key K_{dev_pri} of public key cryptosystem securely held by a camera, and a signature Signature [i] of the frame Frame [i] of the video image is generated.

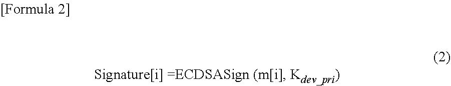

That is, in Equation (2), the signature Signature [i] is obtained by encrypting the message m [i] with the private key K_{dev_pri}, by elliptic curve cryptography (elliptic curve digital signature algorithm (ECDSA)).

Moreover, Equation (3) below is calculated on the basis of the private key K_{dev_pri} and a generation source G on the elliptic curve, and a public key K_{dev_pub} corresponding to the private key K_{dev_pri} of public key cryptosystem is generated.

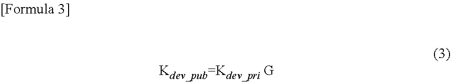

An apparatus on a side that captures and transmits a video image (an apparatus on a transmission side) simultaneously discloses the public key K_{dev_pub}, the signature Signature [i], and the frame Frame [i] of the video image obtained as described above.

That is, the apparatus on the transmission side generates a public key certificate Certificate [i] by concatenating the public key K_{dev_pub} and the signature Signature [i] as shown in the following Equation (4), and sequentially transmits the public key certificate Certificate [i] and the frame Frame [i] of the video image.

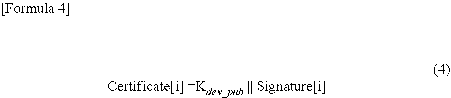

As a result, the public key certificate Certificate [i] and the frame Frame [i] of the video image are transmitted to an apparatus on a reception side for each frame of the video image, such as, for example, Frame [1], Certificate [1], Frame [2], Certificate [2], . . . .

Note that, in Equation (4), “K_{dev_pub}∥Signature [i]” indicates that the public key K_{dev_pub} and the signature Signature [i] are concatenated in the order of the public key K_{dev_pub} and the signature Signature [i], that is, the signature Signature [i] is concatenated after the public key K_{dev_pub}. The “∥” indicating this concatenation is similarly applied to equations described below.

Furthermore, in the apparatus on the reception side, the public key K_{dev_pub} and the signature Signature [i] are extracted from the received public key certificate Certificate [i], and the signature Signature [i] is verified, by elliptic curve cryptography.

In other words, calculation similar to Equation (1) described above is performed on the basis of the frame Frame [i] of the received video image, and the message m [i] is generated.

Then, the signature Signature [i] is verified according to the following Equation (5), on the basis of the message m [i], the public key K_{dev_pub}, and the signature Signature [i].

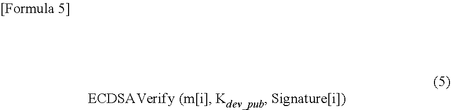

That is, in Equation (5), the signature Signature [i] is verified in the apparatus on the reception side by using the message m [i] obtained from the frame Frame [i] and the public key K_{dev_pub}, by elliptic curve cryptography. As a result, authenticity of the i-th frame Frame [i] of the video image can be verified.

However, in the technique described above, in a case where the frame (Frame [i]) of the video image is removed or in a case where the order of the frames is changed, that is, in a case where falsification such as frame removal or frame order change is performed, such falsification cannot be detected.

Therefore, for example, if a public key certificate and an electronic signature are generated by a verification technique 1 of the present technology described below, falsification such as frame removal and frame order change can be detected.

In the verification technique 1, a video image is divided into time-blocks (Time-Blocks) that are time sections of a predetermined time length, and a session ID corresponding to an identifier of the video image is assigned (generated) for every time-block and stored in signature target data. This session ID is identification information that can uniquely identify each time-block. Furthermore, for example, a video image frame group for ten seconds can be set as one time-block.

Now, in a j-th time-block from the head in the video image, the i-th frame (video image frame) from a head of the time-block is defined as Frame [j] [i].

Furthermore, the session ID for identifying the j-th time-block from the head in the video image is defined as session-id [j]. For example, a size of session-id [j] can be 16 bytes or the like.

Moreover, for example, information indicating a position in the entire video image of the above-described frame Frame [j] [i] which is i-th from a head of the j-th time-block, that is, information indicating the position based on the head of the video image, is defined as frame position information t [i].

For example, the frame position information t [i] can be a frame number from the video image head of the frame Frame [j] [i], a time code of the frame Frame [j] [i], or the like. Furthermore, for example, a size of the frame position information t [i] can be 16 bytes or the like.

In the verification technique 1, the following verification is performed for every frame Frame [j] [i] with reference to session-id [j] and t [i].

By calculating a hash value of data obtained by concatenating the frame Frame [j] [i], session-id [j], and the frame position information t [i] on the basis of the hash function SHA-256 as shown in Equation (6) below, a message m [j] [i] for the frame Frame [j] [i] is obtained.

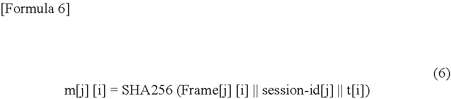

Then, Equation (7) below is calculated on the basis of the message m [j] [i] and the private key K_{dev_pri} Of public key cryptosystem securely held by the camera, and a signature Signature [j] [i] of the frame Frame [j] [i] of the video image is generated.

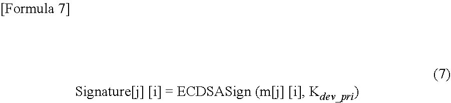

That is, in Equation (7), the signature Signature [j] [i] is obtained by encrypting the message m [j] [i] with the private key K_{dev_pri}, by elliptic curve cryptography (ECDSA).

Moreover, the public key K_{dev_pub} corresponding to the private key K_{dev_pri} is generated (calculated) according to Equation (3) described above, and the public key K_{dev_pub} and the signature Signature [j] [i] are simultaneously disclosed.

Specifically, for example, as shown in the following Equation (8), the public key K_{dev_pub}, session-id [j], and the signature Signature [j] [i] are concatenated to generate a public key certificate Certificate [j] [i].

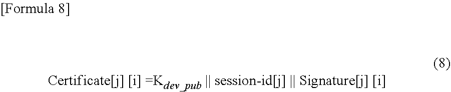

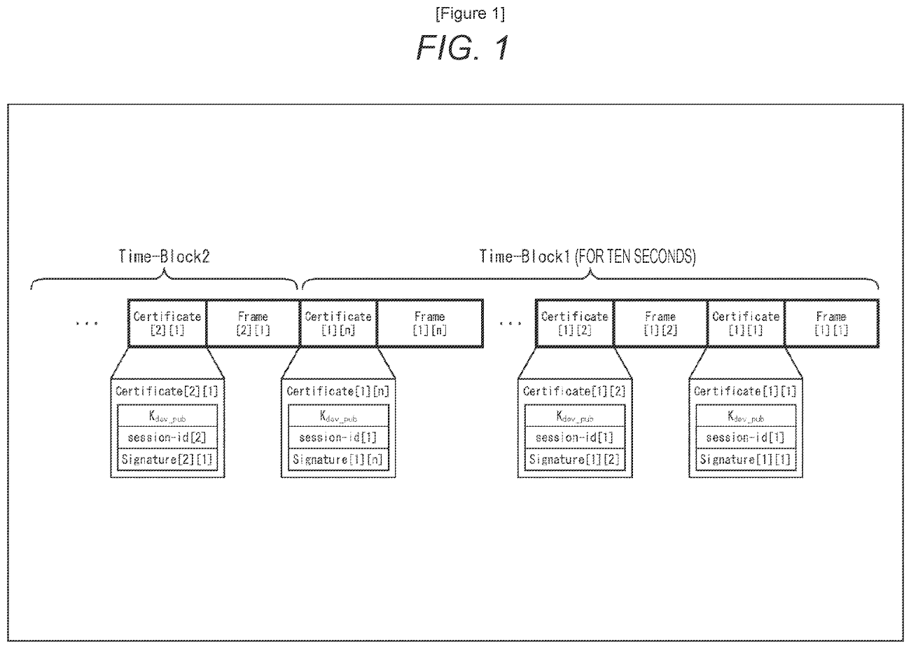

Then, for example, as illustrated in FIG. 1, the frame Frame [j] [i] of the video image and the public key certificate Certificate [j] [i] are sequentially transmitted.

In the example illustrated in FIG. 1, for each frame of the video image, the frame Frame [j] [i] and the public key certificate Certificate [j] [i] are sequentially transmitted to the apparatus on the reception side, such as Frame [1] [1], Certificate [1] [1], Frame [1] [2], Certificate [1] [2], . . . . In particular, in this example, it can be seen that one time-block includes n frames.

Whereas, in the apparatus on the recipient side of the video image, that is, on the reception side of the video image, when the frame Frame [j] [i] of the video image and the public key certificate Certificate [j] [i] are received, the signature Signature [j] [i] is verified.

That is, the apparatus on the reception side extracts the public key K_{dev_pub}, session-id [j], and the signature Signature [j] [i] from the received public key certificate Certificate [j] [i].

Furthermore, the frame position information t [i] about each frame is generated by counting the frame from a head of the received video image and holding the counting result.

Next, the message m [j] [i] is obtained for the frame Frame [j] [i] of the received video image, on the basis of the hash function SHA-256.

That is, the hash value of the data obtained by concatenating the frame Frame [j] [i], session-id [j], and the frame position information t [i] is calculated according to Equation (6) described above, and the message m [j] [i] for the frame Frame [j] [i] is obtained.

Then, the signature Signature [j] [i] is verified according to the following Equation (9), on the basis of the message m [j] [i], the public key K_{dev_pub}, and the signature Signature [j] [i].

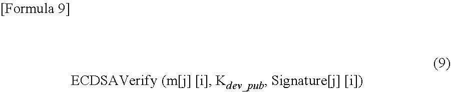

That is, in Equation (9), the signature Signature [j] [i] is verified in the apparatus on the reception side by using the message m [j] [i] obtained from the frame Frame [j] [i] and the public key K_{dev_pub}, by elliptic curve cryptography.

As a result, authenticity of each frame Frame [j] [i] can be verified on a frame basis of the video image. In particular, since the message m [j] [i] includes session-id [j] and the frame position information t [i], it is possible to detect falsification such as frame removal or frame order change.

Specifically, for example, by including session-id [j] in the message m [j] [i], it is possible to detect frame removal, frame order change across time-blocks, falsification of a video image obtained by connecting a plurality of different video images, and the like. Furthermore, by including the frame position information t [i] in the message m [j] [i], it is possible to detect frame removal, frame order change, and the like.

### <Verification Technique 2>

Meanwhile, in the verification technique 1, falsification such as frame removal and frame order change can be detected, but there will be no link to an original video image at a time of transcoding the video image.

Therefore, the video image recipient side can verify the authenticity of the video image after transcoding, but cannot verify that the video image is not replaced, falsified, or the like in the transcoding. That is, there is no trail regarding the video image before transcoding.

This is because, after transcoding, even if the signature Signature [j] [i] of the video image frame Frame [j] [i] before transcoding is continuously held, the video image frame Frame [j] [i] itself before transcoding which is necessary for verification of the signature Signature [j] [i] is lost, and verification becomes impossible.

Therefore, a verification technique 2 of the present technology that enables chaining of public key certificates before and after transcoding of the video image will be described. That is, hereinafter, a generation technique for a public key certificate for enabling verification of a relationship between a video image before being transcoded and a video image after being transcoded will be described.

In the verification technique 2, a private key K_{trans_pri} of public key cryptosystem is added to a video image before transcoding, and a transcoder generates a signature for a public key certificate of a video image after transcoding by using the private key K_{trans_pri}. By generating the signature by using the private key K_{trans_pri} added to the video image before transcoding, a relationship between the video image before transcoding and the video image after transcoding can be verified.

Furthermore, after the signature is generated, the private key K_{trans_pri} is discarded, and a private key K′_{trans_pri} of public key cryptosystem is newly generated and added to the video image after transcoding. Still another transcoder that has received the video image after transcoding further generates a signature for the public key certificate of the video image after transcoding, by using the private key K′_{trans_pri}. By the chaining of signatures by using the private key K_{trans_pri} assigned to the video image before transcoding, a relationship from the received video image to the original video image captured by the camera can be verified.

In particular, here, {K_{trans_pri}, K_{trans_pub}}, {K′_{trans_pri}, K′_{trans_pub}}, {K″_{trans_pri}, K″_{trans_pub}}, . . . , which are pairs (key pairs) of a private key and a public key of public key cryptosystem for chaining the public key certificates Certificate [j] [i], are assumed to be introduced. In particular, here, a new key pair is generated every time the video image is transcoded.

Note that the public key corresponding to the private key can be obtained by calculation similar to Equation (3) described above. That is, K_{trans_pub}=K_{trans_pri}G, K′_{trans_pub}=K′_{trans_pri}G, K″_{trans_pub}=K″_{trans_pri}G, . . . are satisfied.

Hereinafter, the verification technique 2 will be described more specifically.

First, the following processing is performed as signature generation at a time of capturing and distributing an original video image with a camera, which is not video image transcoding.

That is, in the camera, session-id [j], which is the session ID, is assigned for every time-block in the video image obtained by image-capturing, and the private key K_{trans_pri} and the public key K_{trans_pub} are generated, which are a key pair of public key cryptosystem for the original video image.

Then, as shown in Equation (10) below, the public key K_{dev_pub} corresponding to the private key K_{dev_pri} securely held by the camera, session-id [j], and the public key K_{trans_pub} are concatenated to generate signature target data c [j] [i] for the frame Frame [j] [i] of the video image.

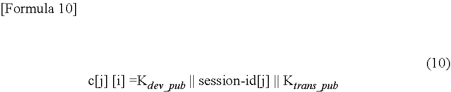

Furthermore, the frame position information t [i] about each frame is generated by counting the frame from the head of the video image and holding the counting result.

Moreover, as shown in Equation (11) below, the frame Frame [j] [i], the signature target data c [j] [i], and the frame position information t [i] are concatenated on the basis of the hash function SHA-256, and the message m [j] [i] for the frame Frame [j] [i] is obtained.

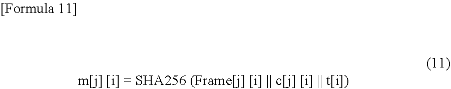

Next, Equation (12) below is calculated on the basis of the message m [j] [i] and the private key K_{dev_pri} of public key cryptosystem securely held by the camera, and the signature Signature [j] [i] of the frame Frame [j] [i] of the video image is generated.

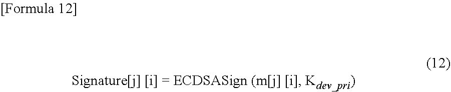

That is, in Equation (12), the signature Signature [j] [i] is obtained by encrypting the message m [j] [i] with the private key K_{dev_pri}, by elliptic curve cryptography.

Next, as shown in Equation (13) below, the signature target data c [j] [i] and the signature Signature [j] [i] are concatenated to generate the public key certificate Certificate [j] [i].

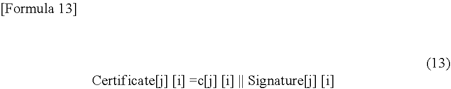

Moreover, as shown in Equation (14) below, the public key certificate Certificate [j] [i] and the private key K_{trans_pri} are concatenated and set as data to be added to the frame Frame [j] [i] of the video image.

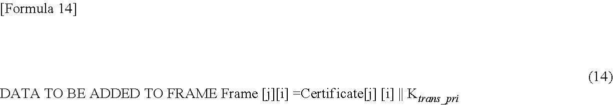

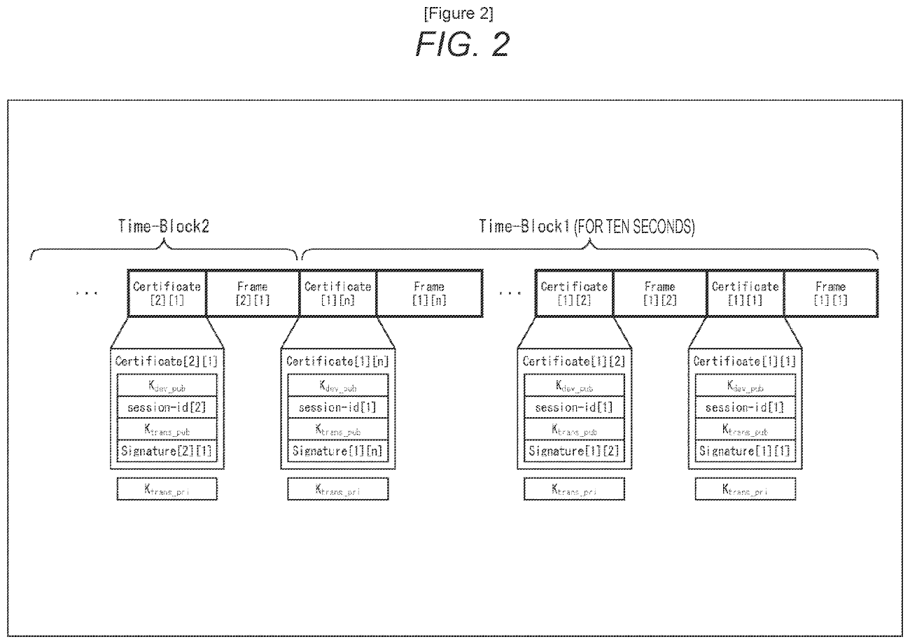

Then, for example, as illustrated in FIG. 2, the frame Frame [j] [i] of the video image, the public key certificate Certificate [j] [i], and the private key K_{trans_pri} are sequentially transmitted.

In FIG. 2, for each frame of the video image, the frame Frame [j] [i], the public key certificate Certificate [j] [i], and the private key K_{trans_pri} are sequentially transmitted to the apparatus on the reception side, such as Frame [1] [1], Certificate [1] [1], K_{trans_pri}, Frame [1] [2], Certificate [1] [2], K_{trans_pri}; . . . . In this example, one time-block includes n frames.

In a case where the apparatus on the video image recipient side, that is, on the reception side of the video image has directly received the original video image captured and distributed by the camera, that is, in a case where no transcoding has occurred, the signature Signature [j] [i] is verified for every frame Frame [j] [i] of the video image.

Here, it is assumed that the transcoder has received the frame Frame [j] [i] of the original video image, the public key certificate Certificate [j] [i], and the private key K_{trans_pri}, from the camera. In this case, the transcoder extracts the signature target data c [j] [i] and the signature Signature [j] [i] from the received public key certificate Certificate [j] [i].

Furthermore, the frame position information t [i] about each frame is generated by counting the frame from a head of the received video image and holding the counting result.

Next, the message m [j] [i] is obtained for the frame Frame [j] [i] of the received video image, on the basis of the hash function SHA-256.

That is, the frame Frame [j] [i], the signature target data c [j] [i], and the frame position information t [i] are concatenated according to Equation (11) described above, a hash value is calculated, and the message m [j] [i] is obtained.

Then, the signature Signature [j] [i] is verified according to the following Equation (15), on the basis of the message m [j] [i], the public key K_{dev_pub} included in the signature target data c [j] [i], and the signature Signature [j] [i].

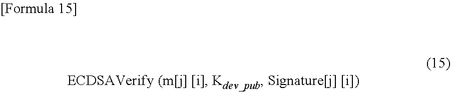

In Equation (15), the signature Signature [j] [i] is verified by using the public key K_{dev_pub} and the message m [j] [i] obtained from the frame Frame [j] [i] by the transcoder, by the elliptic curve cryptography.

As a result, authenticity of each frame Frame [j] [i] can be verified on a frame basis of the video image. In particular, since the message m [j] [i] includes session-id [j] and the frame position information t [i], it is possible to detect falsification such as frame removal and frame order change, similarly to the case of the verification technique 1.

It is assumed that, after such verification of the signature Signature [j] [i], the transcoder performs transcoding on the video image received from the camera, and as a result, each frame Frame′ [j] [i] of the video image after transcoding corresponding to each frame Frame [j] [i] of the original video image is obtained.

Note that, here, at the time of transcoding, conversion in which a time code changes, such as frame rate conversion or 2:3 pull-down, is not performed.

Furthermore, it is assumed that, in the transcoder, a private key K_{transcoder_pri} of public key cryptosystem is securely held, and a public key corresponding to the private key K_{transcoder_pri} is K_{transcoder_pub})=K_{transcoder_pri}G.

In this case, the transcoder generates a signature for each frame Frame′ [j] [i] after transcoding, similarly to the generation of the signature for the original video image frame Frame [j] [i] in the camera.

That is, in the transcoder, session-id [j], which is the session ID, is assigned to the video image after transcoding for every time-block, and the private key K′_{trans_pri} and the public key K′_{trans_pub} are generated, which are a key pair of public key cryptosystem for another transcoder to generate a signature.

Then, as shown in Equation (16) below, the public key K_{transcoder_pub} corresponding to the private key K_{transcoder_pri} securely held by the transcoder, session-id [j], and the public key K′_{trans_pub} are concatenated to generate (configure) the signature target data c′ [j] [i].

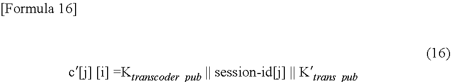

This signature target data c′ [j] [i] is data common to individual video image frames Frame′ [j] [i] in one time-block.

By including the public key K′_{trans_pub} in the signature target data c′ [j] [i], a third party that has received the video image after transcoding and the public key certificate Certificate′ [j] [i] to be described later can perform signature verification using the public key K′_{trans_pub} in the signature target data c′ [j] [i] included in the public key certificate Certificate′ [j] [i]. As a result, it is possible to verify that the public key certificate added to the video image after transcoding frame includes the signature generated by the private key K′_{trans_pri} added to the video image after transcoding frame Frame′ [j] [i].

Furthermore, as shown in Equation (17) below, by calculating a hash value of data obtained by concatenating the frame Frame′ [j] [i], the signature target data c′ [j] [i] obtained according to Equation (16), and the frame position information t [i] on the basis of the hash function SHA-256, a message m′ [j] [i] for the frame Frame′ [j] [i] is obtained.

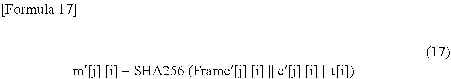

Thereafter, Equation (18) below is calculated on the basis of the message m′ [j] [i] and the private key K_{transcoder_pri} of public key cryptosystem securely held by the transcoder, and the signature Signature [j] [i] of the video image frame Frame′ [j] [i] is generated.

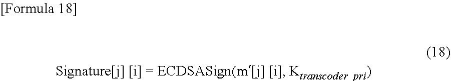

That is, in Equation (18), the signature Signature [j] [i] is obtained by encrypting the message m′ [j] [i] with the private key K_{transcoder_pri}, by the elliptic curve cryptography.

Moreover, for the video image frame Frame′ [j] [i] after transcoding, in addition to signature generation using the private key K_{transcoder_pri}, signature generation using the private key K_{trans_pri} received together with the video image frame Frame [j] [i] from the camera is also performed.

That is, as shown in Equation (19) below, the public key certificate Certificate [j] [i] received from the camera, the public key K_{transcoder_pub} corresponding to the private key K_{transcoder_pri}, and the public key K′_{trans_pub} are concatenated to generate (configure) signature target data c′ [j] [i]. This signature target data c′ [j] [i] is different from that obtained according to Equation (16).

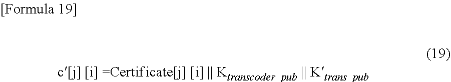

Moreover, Equation (20) below is calculated on the basis of the signature target data c′ [j] [i] obtained according to Equation (19) and the private key K_{trans_pri} received from the camera, and a signature Signature′ [j] [i] for the signature target data c′ [j] [i] including the public key certificate Certificate [j] [i] is generated.

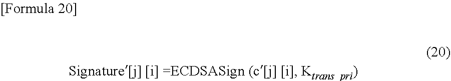

That is, in Equation (20), the signature Signature′ [j] [i] is obtained by encrypting the signature target data c′ [j] [i] with the private key K_{trans_pri}, by the elliptic curve cryptography.

By storing the signature Signature′ [j] [i] obtained in this manner in the public key certificate Certificate′ [j] [i] of the frame Frame′ [j] [i], it becomes possible to verify that the frame Frame′ [j] [i] is generated by converting the frame Frame [j] [i] added with the data obtained by concatenating the public key certificate Certificate [j] [i] and the private key K_{trans_pri} Shown in Equation (14) described above. That is, it is possible to specify (track) that the frame Frame [j] [i] is the original video image of the frame Frame′ [j] [i].

After the signature Signature [j] [i] and the signature Signature′ [j] [i] are generated as described above, a public key certificate Certificate′ [j] [i] is generated according to Equation (21) below.

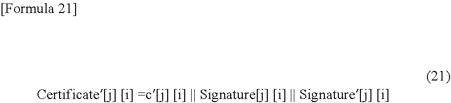

That is, in Equation (21), the signature target data c′ [j] [i] obtained in Equation (19), the signature Signature [j] [i] obtained in Equation (18), and the signature Signature′ [j] [i] obtained in Equation (20) are concatenated to generate the public key certificate Certificate′ [j] [i].

Moreover, as shown in Equation (22) below, the public key certificate Certificate′ [j] [i] and the private key K′_{trans_pri} are concatenated and set as data to be added to the frame Frame′ [j] [i] of the video image.

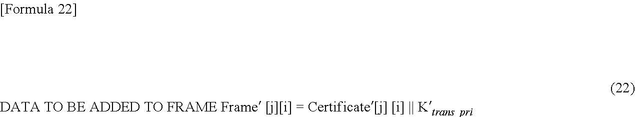

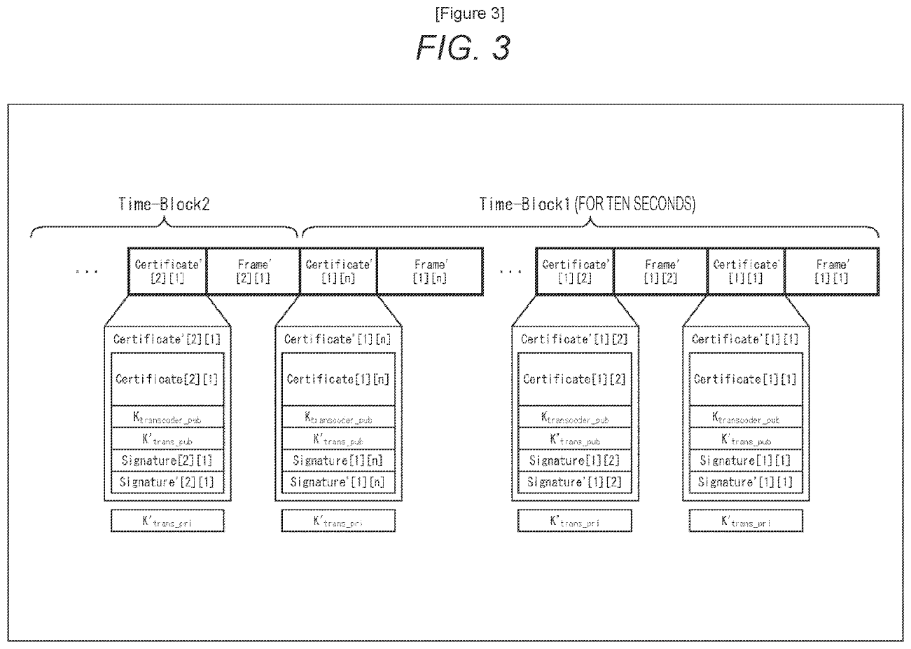

Then, for example, as illustrated in FIG. 3, the frame Frame′ [j] [i] of the video image, the public key certificate Certificate′ [j] [i], and the private key K′_{trans_pri} are sequentially transmitted.

In FIG. 3, for each frame of the video image, the frame Frame′ [j] [i], the public key certificate Certificate′ [j] [i], and the private key K′_{trans_pri} are sequentially transmitted to the apparatus on the reception side, such as Frame′ [1] [1], Certificate′ [1] [1], K′_{trans_pri}, Frame′ [1] [2], Certificate′ [1] [2], K′_{trans_pri}, . . . . In this example, one time-block includes n frames.

Furthermore, as described above, at a time of generating the video image frame Frame′ [j] [i], conversion in which a time code changes, such as frame rate conversion or 2:3 pull-down, is not performed. This is because, if the time code of the video image frame changes before and after transcoding, the time-block and the frame position information t [i] are no longer in one-to-one correspondence in the video images before and after transcoding.

Furthermore, in a case where the apparatus (client) on the recipient side of the video image from the transcoder, that is, on the reception side of the video image has received the video image after transcoding, that is, in a case where the transcoding has occurred, the signature is verified for every video image frame Frame′ [j] [i].

Here, it is assumed that the client has received the frame Frame′ [j] [i] of the video image after transcoding, the public key certificate Certificate′ [j] [i], and the private key K′_{trans_pri}, from the transcoder.

In this case, the client extracts the public key certificate Certificate [j] [i], the public key K_{transcoder_pub}, the public key K′_{trans_pub}, the signature Signature [j] [i], and the signature Signature′ [j] [i] from the received public key certificate Certificate′ [j] [i]. Moreover, the session ID (session-id [j]) and the public key K_{trans_pub} are also extracted from the extracted public key certificate Certificate [j] [i].

Furthermore, the frame position information t [i] for each video image frame Frame′ [j] [i] is generated by counting the frame from the head of the received video image and holding the counting result.

Next, according to Equation (16) described above, the public key K_{transcoder_pub}, session-id [j], and the public key K′_{trans_pub} are concatenated to generate (configure) the common signature target data c′ [j] [i] in the time-block, and the following verification is performed for every frame Frame′ [j] [i].

That is, the message m′ [j] [i] is obtained according to Equation (17) described above, on the basis of the hash function SHA-256 and the data obtained by concatenating the frame Frame′ [j] [i], the signature target data c′ [j] [i] obtained according to Equation (16), and the frame position information t [i].

Then, the signature Signature [j] [i] is verified according to the following Equation (23), on the basis of the message m′ [j] [i], the public key K_{transcoder_pub}, and the signature Signature [j] [i].

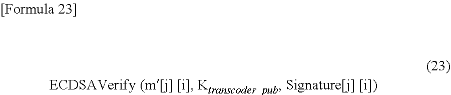

In Equation (23), the signature Signature [j] [i] is verified by the client by using the public key K_{transcoder_pub} and the message m′ [j] [i] obtained from the frame Frame′ [j] [i]t, by elliptic curve cryptography.

As a result, authenticity of the video image frame Frame′ [j] [i] is considered to be verified on a frame basis of the video image. In particular, since the message m′ [j] [i] includes session-id [j] and the frame position information t [i], it is possible to detect falsification such as frame removal and frame order change, similarly to the case of the verification technique 1.

Moreover, the client also verifies the signature Signature′ [j] [i].

That is, the public key certificate Certificate [j] [i], the public key K_{transcoder_pub}, and the public key K′_{trans_pub} are concatenated to generate the signature target data c′ [j] [i] shown in Equation (19) described above.

Then, the signature Signature′ [j] [i] is verified according to the following Equation (24), on the basis of the signature target data c′ [j] [i], the public key K_{trans_pub}, and the signature Signature′ [j] [i].

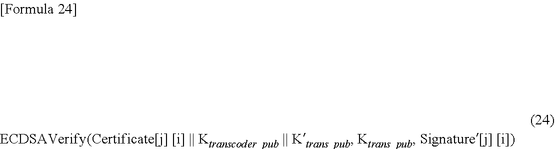

In Equation (24), the signature Signature′ [j] [i] is verified by the client using the public key K_{trans_pub} and the signature target data c′ [j] [i] obtained from the public key certificate Certificate [j] [i], by the elliptic curve cryptography.

As a result, authenticity of the public key certificate Certificate [j] [i] added to the video image frame Frame′ [j] [i] is considered to be verified on a frame basis of the video image. In other words, it is considered to be verified that the frame Frame′ [j] [i] is generated by converting the frame Frame [j] [i], that is, that the frame Frame [j] [i] is the original video image of the frame Frame′ [j] [i].

As described above, according to the verification technique 2, it is possible to ensure the authenticity of the video image after transcoding, and also to ensure the authenticity of the video image before transcoding, that is, to track the original video image.

### <Verification Technique 3>

Meanwhile, in the verification technique 2, in the same time-block, the signature target data c [j] [i] other than the signature Signature [j] [i] is common for the public key certificate Certificate [j] [i] in the public key certificate Certificate′ [j] [i] added to each video image frame Frame′ [j] [i]. In other words, the public key certificate Certificate′ [j] [i] has a redundant structure.

Furthermore, in the verification technique 2, it is necessary to perform signature verification twice for every video image frame Frame′ [j] [i]. That is, it is necessary to verify the signature Signature′ [j] [i] and the signature Signature [j] [i] for every video image frame Frame′ [j] [i].

Therefore, a common value may be separated from the public key certificate Certificate [j] [i] in the time-block, and the separated value may be arranged at a head of the time-block. Hereinafter, such a technique is referred to as a verification technique 3.

According to the verification technique 3, redundancy of the structure of the public key certificate Certificate [j] [i] can be eliminated, and the number of times of signature verification can be reduced. That is, in the verification technique 3, it is sufficient to perform signature verification once for every video image frame, and perform signature verification once for every time-block.

Hereinafter, the verification technique 3 will be described more specifically.

First, the following processing is performed as signature generation at a time of capturing and distributing an original video image with a camera, which is not video image transcoding.

That is, in the camera, session-id [j], which is the session ID, is assigned for every time-block in the video image obtained by image-capturing, and the private key K_{trans_pri} and the public key K_{trans_pub} are generated, which are a key pair of public key cryptosystem for the original video image.

Then, as shown in Equation (25) below, the public key K_{dev_pub} corresponding to the private key K_{dev_pri} securely held by the camera, session-id [j], and the public key K_{trans_pub} are concatenated to generate the signature target data c [j] for the time-block indicated by session-id [j].

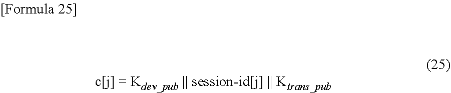

Next, Equation (26) below is calculated on the basis of the signature target data c [j] obtained according to Equation (25) and the private key K_{dev_pri} Of public key cryptosystem securely held by the camera, and a signature Sig [j] for every time-block is generated.

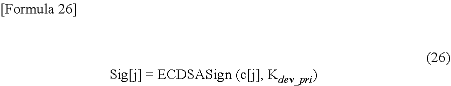

That is, in Equation (26), the signature Sig [j] is obtained by encrypting the signature target data c [j] with the private key K_{dev_pri}, by elliptic curve cryptography.

Furthermore, as shown in Equation (27) below, the signature target data c [j] and the signature Sig [j] are concatenated to generate a public key certificate Certificate [j] for every time-block.

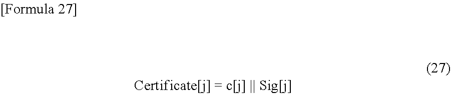

Moreover, as shown in Equation (28) below, the public key certificate Certificate [j] and the private key K_{trans_pri} are concatenated and set as data to be added to a head of the time-block indicated by session-id [j].

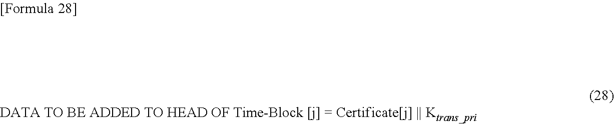

Next, the signature Signature [j] [i] is generated for every video image frame Frame [j] [i].

That is, as shown in Equation (29) below, by calculating a hash value of data obtained by concatenating the frame Frame [j] [i], the signature target data c [j], and the frame position information t [i] on the basis of the hash function SHA-256, the message m [j] [i] for the frame Frame [j] [i] is obtained.

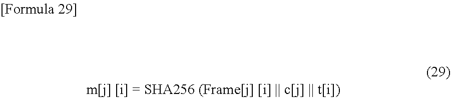

Then, Equation (30) below is calculated on the basis of the message m [j] [i] obtained according to Equation (29) and the private key K_{dev_pri} of public key cryptosystem securely held by the camera, and the signature Signature [j] [i] of the video image frame Frame [j] [i] is generated.

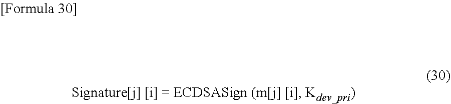

That is, in Equation (30), the signature Signature [j] [i] is obtained by encrypting the message m [j] [i] with the private key K_{dev_pri}, by elliptic curve cryptography.

The signature Signature [j] [i] obtained in this manner is data to be added to the frame Frame [j] [i] as shown by Equation (31) below.

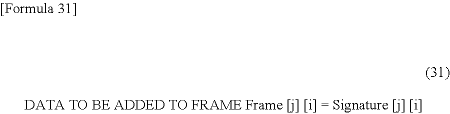

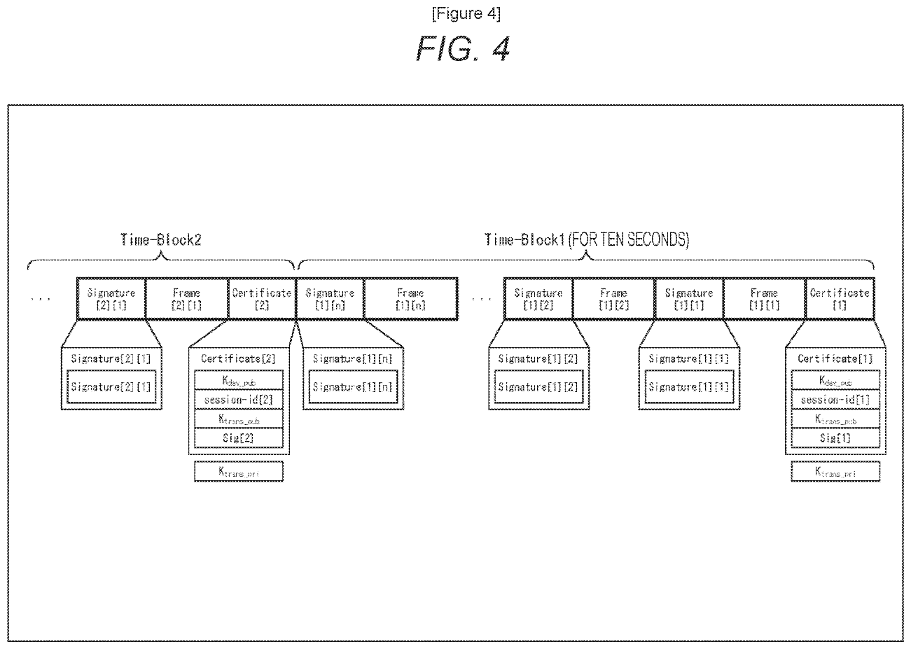

Then, for example, as illustrated in FIG. 4, the public key certificate Certificate [j] and the private key K_{trans_pri}, the video image frame Frame [j] [i], and the signature Signature [j] [i] added to the video image frame Frame [j] [i] are sequentially transmitted.

In FIG. 4, each piece of data is transmitted, such as Certificate [1], K_{trans_pri}, Frame [1] [1], Signature [1] [1], Frame [1] [2], Signature [1] [2], . . . , Certificate [2], K_{trans_pri}, Frame [2] [1], Signature [2] [1], Frame [2] [2], Signature [2] [2], . . . .

That is, the public key certificate Certificate [j] and the private key K_{trans_pri} are transmitted at the head of the time-block, and thereafter, for each frame of the video image, the frame Frame [j] [i] and the signature Signature [j] [i] are sequentially transmitted to the apparatus on the reception side. In this example, one time-block includes n frames.

In a case where the apparatus on the video image recipient side, that is, on the reception side of the video image directly has received the original video image captured and distributed by the camera, that is, in a case where no transcoding has occurred, the following verification is performed.

Here, it is assumed that the transcoder has received the public key certificate Certificate [j], the private key K_{trans_pri}, the frame Frame [j] [i] of the original video image, and the signature Signature [j] [i], from the camera.

In this case, the transcoder extracts the public key K_{dev_pub}, session-id [j], the public key K_{trans_pub}, and the signature Sig [j] from the received public key certificate Certificate [j].

In other words, the signature Sig [j] and the signature target data c [j] of Equation (25) including the public key K_{dev_pub}, session-id [j], and the public key K_{trans_pub} are extracted from the public key certificate Certificate [j].

Then, the signature Sig [j] for every time-block is verified according to Equation (32) below on the basis of the signature target data c [j], the public key K_{dev_pub}, and the signature Sig [j].

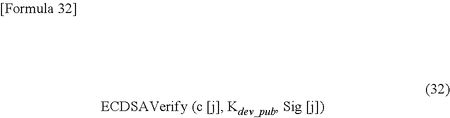

In Equation (32), the signature Sig [j] is verified by using the public key K_{dev_pub} and the signature target data c [j] extracted (read) from the public key certificate Certificate [j] by the transcoder, by elliptic curve cryptography. As a result, authenticity of the public key certificate Certificate [j] can be verified.

Furthermore, by counting the frame Frame [j] [i] from the head of the received video image and holding the counting result, the transcoder generates the frame position information t [i] for each frame Frame [j] [i].

Moreover, the message m [j] [i] is obtained according to Equation (29) described above, on the basis of the hash function SHA-256 and the data obtained by concatenating the frame Frame [j] [i], the signature target data c [j], and the frame position information t [i].

Then, the signature Signature [j] [i] is verified according to the following Equation (33), on the basis of the message m [j] [i], the public key K_{dev_pub}, and the signature Signature [j] [i].

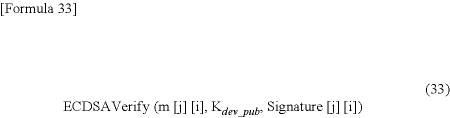

In Equation (33), the signature Signature [j] [i] is verified by using the public key K_{dev_pub} and the message m [j] [i] obtained from the frame Frame [j] [i] by the transcoder, by the elliptic curve cryptography.

As a result, authenticity of the video image frame Frame [j] [i] is considered to be verified on a frame basis of the video image. In particular, in this example, since the message m [j] [i] also includes session-id [j] and the frame position information t [i], it is possible to detect frame removal, frame order change, falsification of a video image obtained by connecting a plurality of different video images, and the like, similarly to the case of the verification technique 1.

It is assumed that, after verification of the signature Sig [j] for every time-block and the signature Signature [j] [i] for every frame as described above, the transcoder performs transcoding on the video image received from the camera, and each frame Frame′ [j] [i] of the video image after transcoding corresponding to each frame Frame [j] [i] of the original video image is obtained as a result.

Note that, also in the verification technique 3, it is assumed that conversion in which a time code changes, such as frame rate conversion or 2:3 pull-down, is not performed at the time of transcoding. That is, it is assumed that transcoding in which the time code does not change is performed.

Furthermore, in the transcoder, similarly to the case of the verification technique 2, it is assumed that the private key K_{transcoder_pri} of public key cryptosystem is securely held.

In this case, the transcoder generates a signature at a time of video image distribution after transcoding as follows.

That is, in the transcoder, the private key K′_{trans_pri} and the public key K′_{trans_pub} are generated, which are a key pair of public key cryptosystem for the video image after transcoding.

Next, as shown in Equation (34) below, the public key certificate Certificate [j], the public key K_{transcoder_pub} corresponding to the private key K_{transcoder_pri} securely held by the transcoder, and the public key K′_{trans_pub} are concatenated to generate (configure) the signature target data c′ [j].

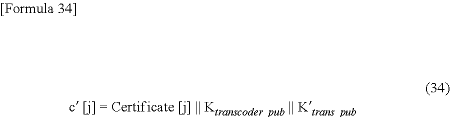

Then, Equation (35) below is calculated on the basis of the signature target data c′ [j] obtained according to Equation (34) and the private key K_{transcoder_pri} securely held by the transcoder, and a signature Sig1′ [j] is generated for every time-block for the public key certificate Certificate [j].

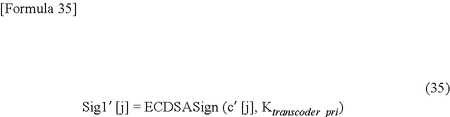

That is, in Equation (35), the signature Sig1′ [j] is obtained by encrypting the signature target data c′ [j] with the private key K_{transcoder_pri}, by elliptic curve cryptography.

Similarly, Equation (36) below is calculated on the basis of the signature target data c′ [j] obtained according to Equation (34) and the private key K_{trans_pri} received from the camera, and a signature Sig2′ [j] is generated for every time-block for the public key certificate Certificate [j].

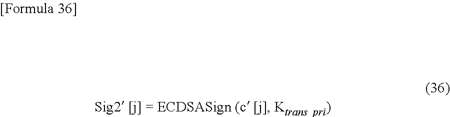

That is, in Equation (36), the signature Sig2′ [j] is obtained by encrypting the signature target data c′ [j] with the private key K_{trans_pri}, by elliptic curve cryptography.

Furthermore, as shown in Equation (37) below, the signature target data c′ [j], the signature Sig1′ [j], and the signature Sig2′ [j] are concatenated to generate the public key certificate Certificate′ [j] for every time-block.

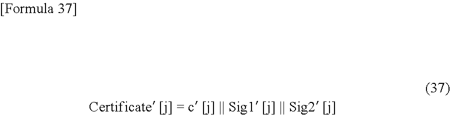

Moreover, the public key certificate Certificate′ [j] and the private key K′_{trans_pri} are concatenated as shown in Equation (38) below, and are set as data to be added to a head of the time-block indicated by session-id [j].

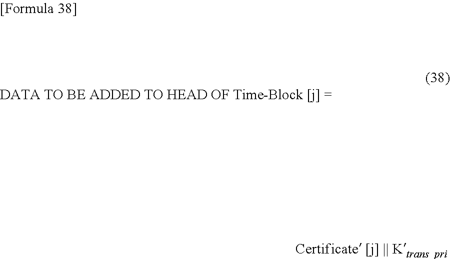

As described above, in the verification technique 3, the generated private key K′_{trans_pri} is added to the frame Frame′ [j] [i] of the video image, and the video image is transmitted.

By doing in this way, in a case where the video image frame Frame′ [j] [i] is further transcoded on the reception side to generate the frame Frame″ [j] [i], the signature target data including the public key certificate Certificate′ [j] can be encrypted with the private key K′_{trans_pri} to generate a signature Sig2″ [j].

As a result, it is possible to verify a relationship between the public key certificate Certificate′ [j] and the public key certificate Certificate″[j] for the frame Frame″ [j] [i], that is, a relationship between video images before and after transcoding.

When the data to be added to the head of the time-block is obtained, next, the signature Signature′ [j] [i] is generated for every video image frame Frame′ [j] [i]. That is, as shown in Equation (39) below, the public key K_{transcoder_pub}, session-id [j], and the public key K′_{trans_pub} are concatenated to generate (configure) signature target data c′ [j]. This signature target data c′ [j] is different from that obtained according to Equation (34).

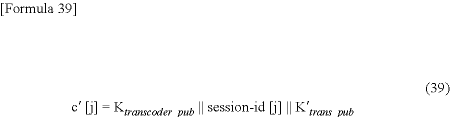

Furthermore, as shown in Equation (40) below, by calculating a hash value of data obtained by concatenating the frame Frame [j] [i], the signature target data c [j], and the frame position information t [i] on the basis of the hash function SHA-256, the message m′ [j] [i] for the frame Frame [j] [i] is obtained.

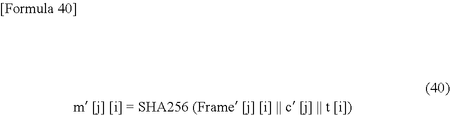

Then, Equation (41) below is calculated on the basis of the message m′ [j] [i] obtained according to Equation (40) and the private key K_{transcoder_pri} of public key cryptosystem securely held by the transcoder, and the signature Signature′ [j] [i] of the video image frame Frame′ [j] [i] is generated.

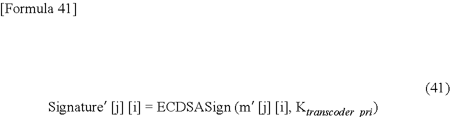

That is, in Equation (41), the signature Signature′ [j] [i] is obtained by encrypting the message m′ [j] [i] with the private key K_{transcoder_pri}, by elliptic curve cryptography.

Moreover, as shown in Equation (42) below, the signature Signature′ [j] [i] is set as data to be added to the frame Frame′ [j] [i] of the video image.

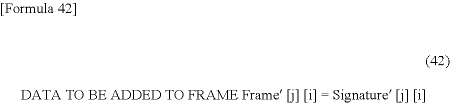

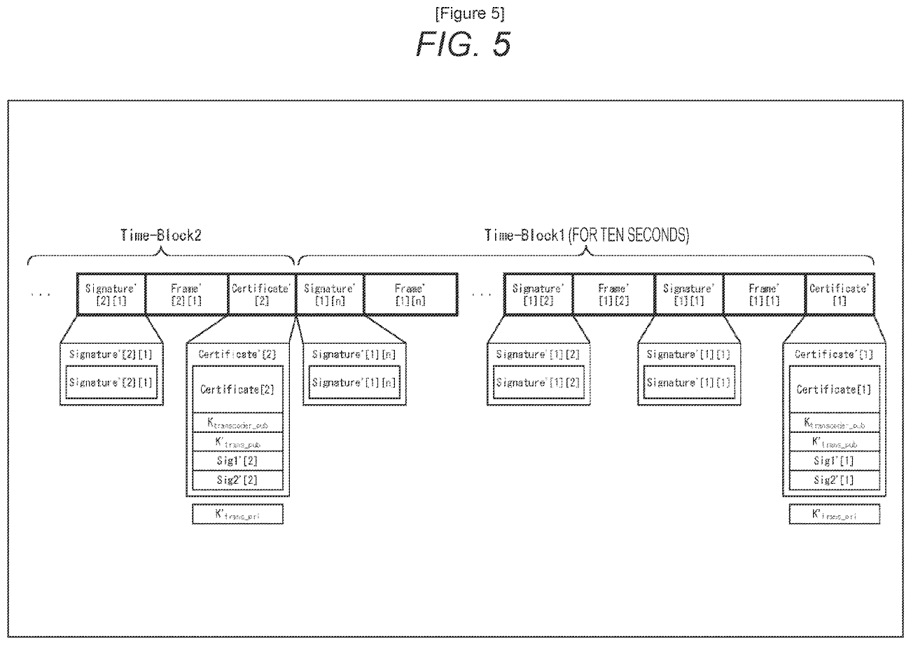

Then, for example, as illustrated in FIG. 5, the public key certificate Certificate′ [j] and the private key K′_{trans_pri}, the video image frame Frame′ [j] [i], and the signature Signature′ [j] [i] added to the video image frame Frame′ [j] [i] are sequentially transmitted.

In FIG. 5, each piece of data is transmitted, such as Certificate′ [1], K′_{trans_pri}, Frame′ [1] [1], Signature′ [1] [1], Frame′ [1] [2], Signature′ [1] [2], . . . , Certificate′ [2], K′_{trans_pri}, Frame′ [2] [1], Signature′ [2] [1], Frame′ [2] [2], Signature′ [2] [2], . . . .

That is, the public key certificate Certificate′ [j] and the private key K′_{trans_pri} are transmitted at the head of the time-block, and thereafter, for each frame of the video image, the frame Frame′ [j] [i] and the signature Signature′ [j] [i] are sequentially transmitted to the apparatus (client) on the reception side. In this example, one time-block includes n frames.

Furthermore, in this example, the private key K_{trans_pri} received from the camera is discarded after the generation of the signature Sig2′ [j], and is not transmitted to the client.

In a case where the apparatus (client) on the recipient side of the video image from the transcoder, that is, on the reception side of the video image has received the video image after transcoding, that is, in a case where the transcoding has occurred, the following verification is performed.

Here, it is assumed that the client has received the public key certificate Certificate′ [j], the private key K′_{trans_pri}, the frame Frame′ [j] [i] of the video image after transcoding, and the signature Signature′ [j] [i], from the transcoder.

In this case, the client extracts the public key certificate Certificate [j], the public key K_{transcoder_pub}, the public key K′_{trans_pub}, the signature Sig1′ [j], and the signature Sig2′ [j] from the received public key certificate Certificate′ [j]. Moreover, the signature Sig [j] and the signature target data c [j], that is, the public key K_{dev_pub}, session-id [j], and K_{trans_pub}, are extracted from the extracted public key certificate Certificate [j].

Furthermore, the frame Frame′ [j] [i] is counted from the head of the received video image, the counting result is held, and the frame position information t [i] for each frame Frame′ [j] [i] is generated.

In the client, first, the signature Sig [j] for every time-block is verified according to Equation (32) described above, on the basis of the signature target data c [j], the public key K_{dev_pub}, and the signature Sig [j].

Subsequently, by concatenating the public key certificate Certificate [j], the public key K_{transcoder_pub}, and the public key K′_{trans_pub} as in Equation (34) described above, the signature target data c′ [j] is generated.

Then, the signature Sig1′ [j] for every time-block is verified according to Equation (43) below, on the basis of the generated signature target data c′ [j], public key K_{transcoder_pub}, and signature Sig1′ [j].

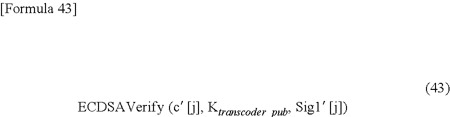

In Equation (43), the signature Sig1′ [j] is verified by using the public key K_{transcoder_pub} and the signature target data c′ [j] generated from the public key certificate Certificate [j] by the transcoder, by the elliptic curve cryptography.

Similarly, the signature Sig2′ [j] for every time-block is verified according to Equation (44) below, on the basis of the generated signature target data c′ [j], public key K_{trans_pub}, and signature Sig2′ [j].

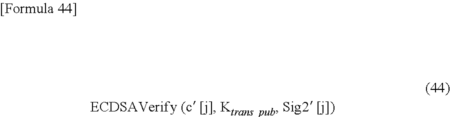

In Equation (44), the signature Sig2′ [j] is verified by using the public key K_{trans_pub} and the signature target data c′ [j] generated from the public key certificate Certificate [j] by the transcoder, by the elliptic curve cryptography.

By the verification of the signature Sig1′ [j] and the signature Sig2′ [j] described above, authenticity of the public key certificate Certificate [j] and authenticity of the public key certificate Certificate′ [j] are verified, and a relationship between the public key certificate Certificate [j] and the public key certificate Certificate′ [j], that is, a relationship between video images before and after transcoding is also verified.

Furthermore, from the public key K_{dev_pub} included in the public key certificate Certificate [j], it can be specified that the original video image before transcoding is output by the camera corresponding to the public key K_{dev_pub}.

Similarly, from the public key K_{transcoder_pub} included in the public key certificate Certificate′ [j], it can be specified that the video image after transcoding is output by the transcoder corresponding to the public key K_{transcoder_pub}.

Moreover, thereafter, the client also verifies the signature Signature′ [j] [i].

That is, the public key K_{transcoder_pub}, session-id [j], and the public key K′_{trans_pub} are concatenated according to Equation (39) described above to generate the signature target data c′ [j].

Furthermore, a hash value of data obtained by concatenating the frame Frame′ [j] [i], the signature target data c′ [j], and the frame position information t [i] is calculated according to Equation (40) described above on the basis of the hash function SHA-256, and the message m′ [j] [i] is obtained.

Then, the signature Signature′ [j] [i] is verified according to the following Equation (40), on the basis of the message m′ [j] [i] obtained according to Equation (45), the public key K_{transcoder_pub}, and the signature Signature′ [j] [i].

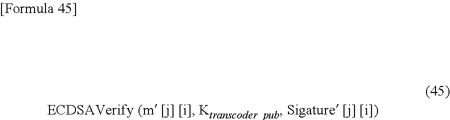

In Equation (45), the signature Signature′ [j] [i] is verified by the client using the public key K_{transcoder_pub} and the message m′ [j] [i] obtained from the frame Frame′ [j] [i], by the elliptic curve cryptography.

As a result, authenticity of the video image frame Frame′ [j] [i] is considered to be verified on a frame basis of the video image. In particular, since the message m′ [j] [i] includes session-id [j] and the frame position information t [i], it is possible to detect falsification such as frame removal and frame order change, similarly to the case of the verification technique 1.

As described above, according to the verification technique 3, it is possible to ensure the authenticity of the video image after transcoding, and also to ensure the authenticity of the video image before transcoding, that is, to track the original video image.

Moreover, in the verification technique 3, the public key certificate Certificate′ [j] including data common to time-blocks, such as the signature target data c [j], is generated for every time-block. As a result, the redundancy of data to be transmitted can be reduced as compared with the case of the verification technique 2, and the number of times of signature verification to be performed, that is, a processing amount for verification can also be reduced.

Note that, regarding the public key K_{dev_pub} and the public key K_{transcoder_pub} corresponding to the private key K_{dev_pri} and the private key K_{transcoder_pri}, it is conceivable to adopt operation on a public key management infrastructure.

In this way, for a device such as a camera, a device identifier allowing identification of a manufacturer and a device individual worldwide can be associated with the public key K_{dev_pub}, and a software identifier allowing identification of a manufacturer and a transcoder individual worldwide can be associated with the public key K_{transcoder_pub}.

Furthermore, a public key certificate in which the public key K_{dev_pub} and the public key K_{transcoder_pub} corresponding to the private key K_{dev_pri} and the private key K_{transcoder_pri} are signed by an appropriate certificate authority may be distributed to a video image recipient in advance.

In such a case, it is not necessary to store the public key K_{dev_pub} in the public key certificate Certificate [j], and operation can be performed by storing ID information indicating an owner of the public key K_{dev_pub}. In this case, the client can dynamically obtain the public key K_{dev_pub} on the basis of the ID information.

Similarly, it is not necessary to store the public key K_{transcoder_pub} in the public key certificate Certificate′ [j], and operation can be performed by storing the ID information indicating an owner of the public key K_{transcoder_pub}.

In addition, an example in which a signature is generated by elliptic curve cryptography (ECDSA) has been described above, but a signature generation system may be any other system such as an RSA encryption system.

### <Configuration Example of Video Image Distribution System>

Subsequently, a more specific embodiment to which the present technology described above is applied will be described. In particular, an example in which the above-described verification technique 3 is applied will be described below.

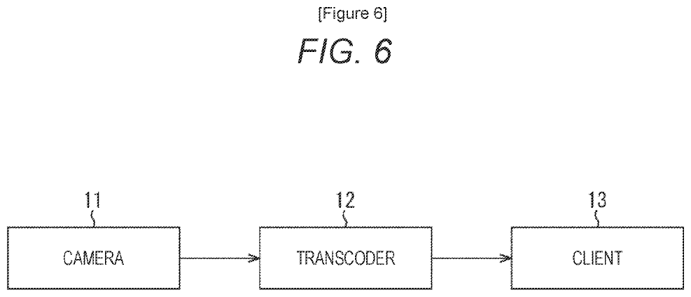

FIG. 6 is a diagram illustrating a configuration example of an embodiment of a video image distribution system to which the present technology is applied.

The video image distribution system illustrated in FIG. 6 has a camera 11, a transcoder 12, and a client 13.

The camera 11 captures a video image to be distributed, and transmits the obtained video image to the transcoder 12. For example, the video image is transmitted (distributed) from the camera 11 to the transcoder 12 in the format illustrated in FIG. 4.

The transcoder 12 verifies the video image received from the camera 11, transcodes the received video image, and transmits the video image after transcoding to the client 13. For example, the video image is transmitted (distributed) from the transcoder 12 to the client 13 in the format illustrated in FIG. 5.

The client 13 receives the video image from the transcoder 12, verifies the received video image, and displays and records the received video image.

### <Configuration Example of Camera>

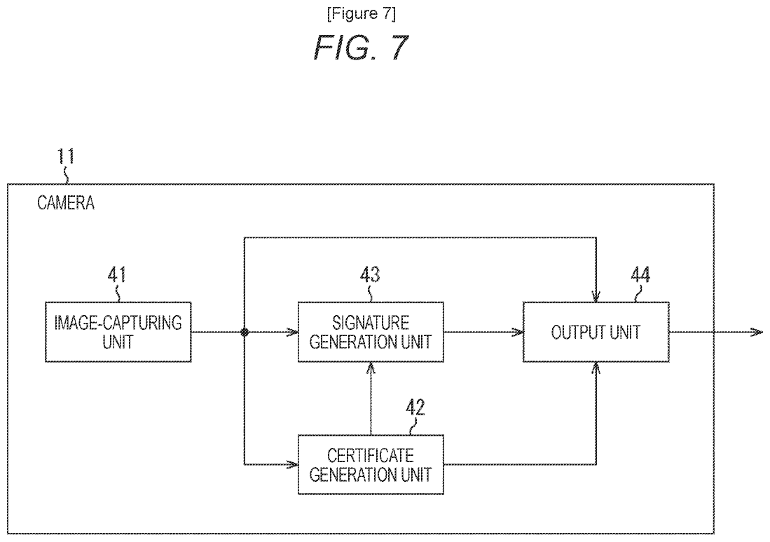

FIG. 7 is a diagram illustrating a configuration example of the camera 11.

The camera 11 is, for example, a device such as a camera having an image-capturing function, and has an image-capturing unit 41, a certificate generation unit 42, a signature generation unit 43, and an output unit 44.

The image-capturing unit 41 includes, for example, an image sensor and the like, captures an image of a predetermined subject, and supplies a video image (continuous still images) obtained as a result to the certificate generation unit 42, the signature generation unit 43, and the output unit 44.

The certificate generation unit 42 generates a public key certificate for every time-block obtained by dividing the video image for the video image supplied from the image-capturing unit 41, supplies the public key certificate to the output unit 44, and supplies various types of information (data) necessary for generating a signature to the signature generation unit 43.

The signature generation unit 43 generates the signature for the video image, on the basis of the video image supplied from the image-capturing unit 41 and the information supplied from the certificate generation unit 42, and supplies the signature to the output unit 44.

The output unit 44 outputs (transmits), to the transcoder 12, the public key certificate supplied from the certificate generation unit 42, the video image supplied from the image-capturing unit 41, and the signature supplied from the signature generation unit 43.

### <Description of Video Image Output Processing>

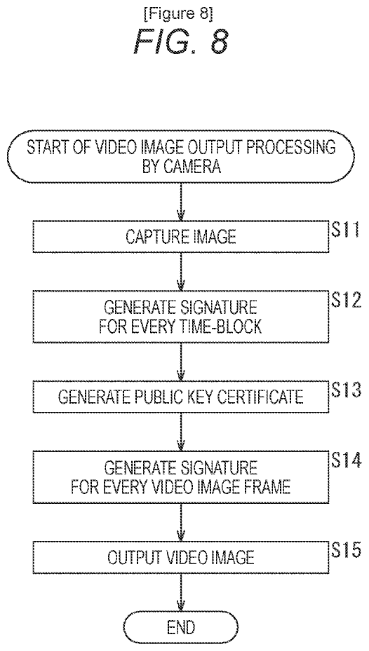

Next, an operation of the camera 11 will be described. That is, with reference to a flowchart of FIG. 8, video image output processing performed by the camera 11 will be described below.

In step S11, the image-capturing unit 41 captures an image of a subject, and sequentially supplies the frames Frame [j] [i] of the video image obtained as a result, to the certificate generation unit 42, the signature generation unit 43, and the output unit 44.

In step S12, the certificate generation unit 42 generates the signature Sig [j] for every time-block on the basis of the frame Frame [j] [i] of the video image supplied from the image-capturing unit 41.

That is, the certificate generation unit 42 divides the video image supplied from the image-capturing unit 41 into time-blocks, and assigns session-id [j] to each time-block.

Furthermore, the certificate generation unit 42 reads the private key K_{dev_pri} and the public key K_{dev_pub} Of the camera 11 securely held in a recording unit (not illustrated) of the camera 11. Note that the public key K_{dev_pub} may be recorded in advance, or may be derived by the certificate generation unit 42 according to Equation (3) described above on the basis of the private key K_{dev_pri}.

Moreover, the certificate generation unit 42 generates the private key K_{trans_pri} for the video image frame Frame [j] [i] by generating a random number, and derives (generates) the public key K_{trans_pub} by performing calculation similar to Equation (3) described above on the basis of the private key K_{trans_pri}.

Then, the certificate generation unit 42 concatenates the public key K_{dev_pub}, session-id [j], and the public key K_{trans_pub} according to Equation (25) to generate the signature target data c [j] for every time-block.

Moreover, the certificate generation unit 42 calculates Equation (26), on the basis of the signature target data c [j] of Equation (25) and the private key K_{dev_pri}, and generates the signature Sig [j] for every time-block.

In step S13, the certificate generation unit 42 generates the public key certificate Certificate [j] including the signature Sig [j] for every time-block obtained in step S12.

That is, the certificate generation unit 42 generates the public key certificate Certificate [j] for every time-block by concatenating the signature target data c [j] obtained according to Equation (25) and the signature Sig [j] as shown in Equation (27).

The certificate generation unit 42 concatenates the public key certificate Certificate [j] obtained in this manner and the private key K_{trans_pri} as shown in Equation (28), and supplies to the output unit 44.

Furthermore, the certificate generation unit 42 supplies the private key K_{dev_pri} and the signature target data c [j] which are necessary for the signature Signature [j] [i] for every video image frame Frame [j] [i], to the signature generation unit 43.

In step S14, the signature generation unit 43 generates the signature Signature [j] [i] for every video image frame Frame [j] [i], on the basis of the video image frame Frame [j] [i] supplied from the image-capturing unit 41 and on the basis of the private key K_{dev_pri} and the signature target data c [j] supplied from the certificate generation unit 42.

For example, the signature generation unit 43 counts the number of frames from the video image head for the video image supplied from the image-capturing unit 41, generates the frame position information t [i] for every frame Frame [j] [i], and calculates Equation (29) to calculate the message m [j] [i].

That is, by calculating a hash value of data obtained by concatenating the frame Frame [j] [i], the signature target data c [j] of Equation (25), and the frame position information t [i] on the basis of the hash function SHA-256, the signature generation unit 43 calculates the message m [j] [i] for the frame Frame [j] [i].

Furthermore, the signature generation unit 43 generates the signature Signature [j] [i] for every video image frame Frame [j] [i] by calculating Equation (30) described above on the basis of the message m [j] [i] obtained by calculation of Equation (29) and the private key K_{dev_pri}, and supplies to the output unit 44.

In step S15, the output unit 44 outputs the video image supplied from the image-capturing unit 41 to the transcoder 12 via a wired or wireless network, cable, or the like, and the video image output processing ends.

That is, the output unit 44 outputs the public key certificate Certificate [j] and the private key K_{trans_pri} supplied from the certificate generation unit 42, at the head of the time-block as illustrated in FIG. 4, for example. Furthermore, the output unit 44 outputs the video image frame Frame [j] [i] supplied from the image-capturing unit 41 and the signature Signature [j] [i] supplied from the signature generation unit 43, for every frame of the video image.

As described above, the camera 11 generates the signature Sig [j] including session-id [j] for every time-block, and generates the signature Signature [j] [i] including session-id [j], the frame position information t [i], and the frame Frame [j] [i], for every frame Frame [j] [i].

By doing in this way, in addition to ensuring authenticity related to the video image, it becomes possible to track the original video image in the subsequent stage of the camera 11, and also to reduce a processing amount for verification.

### <Configuration Example of Transcoder>

Next, a configuration and an operation of the transcoder 12 illustrated in FIG. 6 will be described.

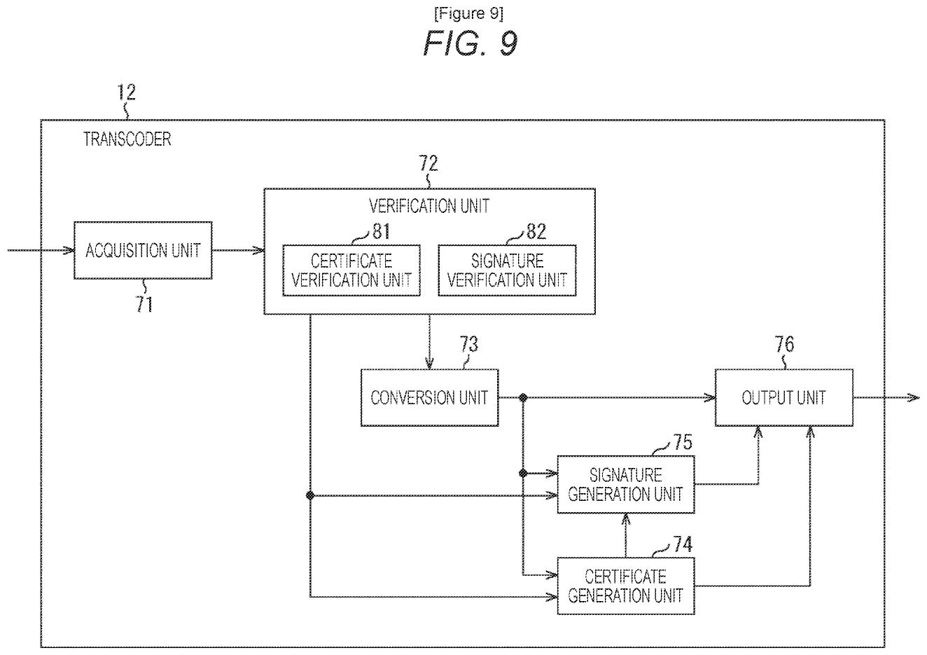

FIG. 9 is a diagram illustrating a configuration example of the transcoder 12.

The transcoder 12 includes, for example, an information processing apparatus such as a computer having a transcode function, and has an acquisition unit 71, a verification unit 72, a conversion unit 73, a certificate generation unit 74, a signature generation unit 75, and an output unit 76.

The acquisition unit 71 acquires (receives) the public key certificate Certificate [j], the private key K_{trans_pri}, the video image frame Frame [j] [i], and the signature Signature [j] [i] output from the output unit 44 of the camera 11, and supplies to the verification unit 72.

The verification unit 72 verifies the public key certificate Certificate [j] and the signature Signature [j] [i] supplied from the acquisition unit 71, and supplies the video image frame Frame [j] [i] to the conversion unit 73 in accordance with the verification result. Furthermore, the verification unit 72 supplies the public key certificate Certificate [j] and the private key K_{trans_pri} to the certificate generation unit 74, and supplies the public key certificate Certificate [j] to the signature generation unit 75.

The verification unit 72 has a certificate verification unit 81 that verifies the public key certificate Certificate [j], and a signature verification unit 82 that verifies the signature Signature [j] [i].

The conversion unit 73 converts the video image frame Frame [j] [i] into the video image frame Frame′ [j] [i] by performing transcoding on the video image frame Frame [j] [i] supplied from the verification unit 72. In the conversion unit 73, because transcoding in which a time code does not change is performed, session-id [j] and the frame position information t [i] do not change (are the same) between the video image frame Frame [j] [i] and the video image frame Frame′ [j] [i].

The conversion unit 73 supplies the video image frame Frame′ [j] [i] obtained by the transcoding, to the certificate generation unit 74, the signature generation unit 75, and the output unit 76.

The certificate generation unit 74 generates a public key certificate Certificate′ [j] for every time-block on the basis of the public key certificate Certificate [j] and the private key K_{trans_pri} supplied from the verification unit 72 and on the basis of the video image frame Frame′ [j] [i] supplied from the conversion unit 73, and supplies the public key certificate Certificate′ [j] to the output unit 76.

Furthermore, the certificate generation unit 74 supplies, to the signature generation unit 75, various types of information (data) necessary for generating the signature Signature′ [j] [i].

The signature generation unit 75 generates the signature Signature′ [j] [i] for every video image frame Frame′ [j] [i] on the basis of the public key certificate Certificate [j] supplied from the verification unit 72, the video image frame Frame′ [j] [i] supplied from the conversion unit 73, and the information supplied from the certificate generation unit 74, and supplies the signature Signature′ [j] [i] to the output unit 76.

The output unit 76 outputs (transmits), to the client 13, the public key certificate Certificate′ [j] supplied from the certificate generation unit 74, the video image frame Frame′ [j] [i] supplied from the conversion unit 73, the signature Signature′ [j] [i] supplied from the signature generation unit 75, and the like.

### <Description of Verification Processing>

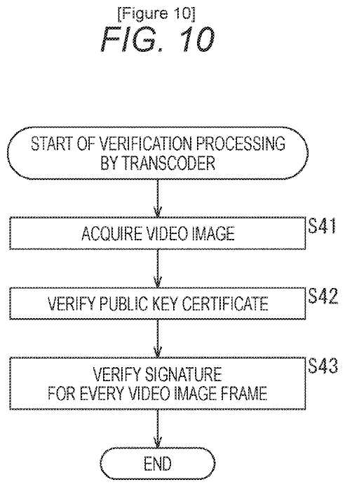

When a video image or the like is transmitted from the camera 11, the transcoder 12 starts verification processing. Hereinafter, verification processing performed by the transcoder 12 will be described with reference to a flowchart in FIG. 10.

In step S41, the acquisition unit 71 acquires (receives) the public key certificate Certificate [j], the private key K_{trans_pri}, the video image frame Frame [j] [i], and the signature Signature [j] [i] transmitted from the camera 11, and supplies to the verification unit 72.

In step S42, the certificate verification unit 81 verifies the public key certificate Certificate [j] for every time-block supplied from the acquisition unit 71. For example, the certificate verification unit 81 extracts the signature Sig [j] and the signature target data c [j] including the public key K_{dev_pub}, session-id [j], and the public key K_{trans_pub}, from the public key certificate Certificate [j].

Then, the certificate verification unit 81 verifies the public key certificate Certificate [j] for every time-block, that is, the signature Sig [j], by performing arithmetic operation of Equation (32) described above, on the basis of the extracted signature target data c [j], public key K_{dev_pub}, and signature Sig [j].

In step S43, the signature verification unit 82 verifies the signature Signature [j] [i] for every video image frame Frame [j] [i] supplied from the acquisition unit 71.

That is, the signature verification unit 82 generates the frame position information t [i] for every frame Frame [j] [i], by counting the number of frames from a head of the received video image.

Furthermore, the signature verification unit 82 obtains the message m [j] [i] according to Equation (29) described above, on the basis of the hash function SHA-256 and the data obtained by concatenating the frame Frame [j] [i], the signature target data c [j] extracted by the certificate verification unit 81, and the frame position information t [i].

Then, the signature verification unit 82 verifies the signature Signature [j] [i] according to Equation (33) described above, on the basis of the message m [j] [i], the public key K_{dev_pub} extracted by the certificate verification unit 81, and the signature Signature [j] [i]. As a result, authenticity of the video image frame Frame [j] [i] is considered to be verified on a frame basis of the video image. In particular, in this example, it is possible to detect frame removal, frame order change, falsification of a video image obtained by connecting a plurality of different video images, and the like.

When the public key certificate Certificate [j] and the signature Signature [j] [i] are verified and the authenticity is confirmed, the verification unit 72 supplies the video image frame Frame [j] [i] to the conversion unit 73.

Furthermore, the verification unit 72 supplies the public key certificate Certificate [j] and the private key K_{trans_pri} to the certificate generation unit 74, and supplies the public key certificate Certificate [j] to the signature generation unit 75, and the verification processing ends.

As described above, the transcoder 12 verifies the public key certificate Certificate [j] and the signature Signature [j] [i] for the video image received from the camera 11. By doing in this way, falsification or the like of the video image can be detected.

### <Description of Video Image Output Processing>

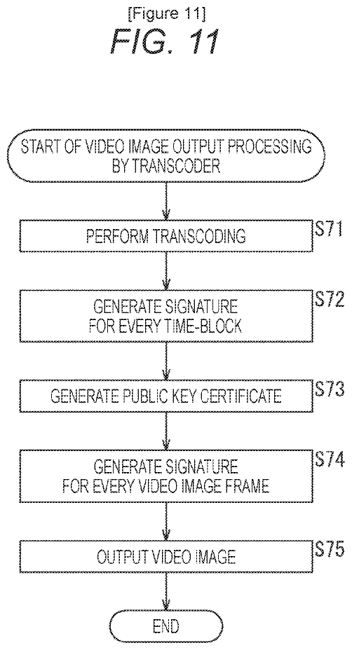

Furthermore, after the public key certificate Certificate [j] and the signature Signature [j] [i] are verified, the transcoder 12 starts video image output processing of transcoding and outputting the video image at any timing. Hereinafter, video image output processing performed by the transcoder 12 will be described with reference to a flowchart of FIG. 11.

In step S71, the conversion unit 73 performs transcoding on the video image frame Frame [j] [i] supplied from the verification unit 72, and supplies the video image frame Frame′ [j] [i] obtained as a result to the certificate generation unit 74, the signature generation unit 75, and the output unit 76.

In step S72, the certificate generation unit 74 generates a signature for every time-block on the basis of the public key certificate Certificate [j] and the private key K_{trans_pri} supplied from the verification unit 72 and on the basis of the video image frame Frame′ [j] [i] supplied from the conversion unit 73.

That is, the certificate generation unit 74 reads the private key K_{transcoder_pri} and the public key K_{transcoder_pub} of the transcoder 12, which are securely held in a recording unit (not illustrated) of the transcoder 12. Note that the public key K_{transcoder_pub} may be recorded in advance, or may be derived by the certificate generation unit 74 through arithmetic operation similar to Equation (3) described above on the basis of the private key K_{transcoder_pri}.

Furthermore, the certificate generation unit 74 generates the private key K′_{trans_pri} for the video image frame Frame′ [j] [i] by generating a random number, and derives (generates) the public key K′_{trans_pub} by performing calculation similar to Equation (3) described above on the basis of the private key K′_{trans_pri}.

Then, the certificate generation unit 74 concatenates the public key certificate Certificate [j], the public key K_{transcoder_pub}, and the public key K′_{trans_pub} according to Equation (34) to generate the signature target data c′ [j].

The certificate generation unit 74 generates the signature Sig1′ [j] for every time-block for the public key certificate Certificate [j], by performing arithmetic operation of Equation (35) described above on the basis of the obtained signature target data c′ [j] and the private key K_{transcoder_pri}.

Furthermore, the certificate generation unit 74 generates the signature Sig2′ [j] for every time-block for the public key certificate Certificate [j], by performing arithmetic operation of Equation (36) described above, on the basis of the obtained signature target data c′ [j] and the private key K_{trans_pri}.

After the signature Sig2′ [j] is generated, the certificate generation unit 74 discards the private key K_{trans_pri}. That is, the private key K_{trans_pri} is not stored in the public key certificate Certificate′ [j] generated by the transcoder 12. By doing in this way, falsification of the public key certificate Certificate [j] can be detected.

In step S73, the certificate generation unit 74 generates the public key certificate Certificate′ [j] on the basis of the signature target data c′ [j], the signature Sig1′ [j], and the signature Sig2′ [j] generated in step S72.

For example, the certificate generation unit 74 generates the public key certificate Certificate′ [j] for every time-block by concatenating the signature target data c′ [j], the signature Sig1′ [j], and the signature Sig2′ [j], according to Equation (37) described above.

Furthermore, the certificate generation unit 74 concatenates the public key certificate Certificate′ [j] and the private key K′_{trans_pri} according to Equation (38) to set as data to be added to a head of the time-block, and supplies the data to the output unit 76.

Furthermore, the certificate generation unit 74 supplies the private key K_{transcoder_pri}, the public key K_{transcoder_pub}, and the public key K′_{trans_pub} necessary for generating the signature Signature′ [j] [i], to the signature generation unit 75.

In step S74, the signature generation unit 75 generates the signature Signature′ [j] [i] for every video image frame Frame′ [j] [i] and supplies to the output unit 76.

For example, the signature generation unit 75 extracts session-id [j] from the public key certificate Certificate [j] of each time-block supplied from the verification unit 72.

Furthermore, by counting the number of frames from the head of the video image supplied from the conversion unit 73, the signature generation unit 75 generates the frame position information t [i] for every frame Frame′ [j] [i].

Then, the signature generation unit 75 generates the signature target data c′ [j] by concatenating the public key K_{transcoder_pub} supplied from the certificate generation unit 74, session-id [j], and the public key K′_{trans_pub} supplied from the certificate generation unit 74, according to Equation (39) described above.

Furthermore, the signature generation unit 75 calculates a hash value of data obtained by concatenating the frame Frame′ [j] [i], the signature target data c′ [j] obtained according to Equation (39), and the frame position information t [i], according to Equation (40) on the basis of the hash function SHA-256, and obtains the message m′ [j] [i].

The signature generation unit 75 generates the signature Signature′ [j] [i] for every video image frame Frame′ [j] [i] by performing arithmetic operation of Equation (41) described above on the basis of the obtained message m′ [j] [i] and the private key K_{transcoder_pri} supplied from the certificate generation unit 74, and supplies the signature Signature′ [j] [i] to the output unit 76.

In step S75, the output unit 76 outputs the video image supplied from the conversion unit 73 to the client 13 via a wired or wireless network, cable, or the like, and the video image output processing ends.

That is, the output unit 76 outputs the public key certificate Certificate [j] and the private key K′_{trans_pri} supplied from the certificate generation unit 74, at the head of the time-block as illustrated in FIG. 5, for example. Furthermore, the output unit 76 outputs the video image frame Frame [j] [i] supplied from the conversion unit 73 and the signature Signature [j] [i] supplied from the signature generation unit 75, for every frame of the video image.

As described above, the transcoder 12 generates the public key certificate Certificate′ [j] including the original public key certificate Certificate [j] for every time-block, and generates the signature Signature′ [j] [i] for every video image frame Frame′ [j] [i].

By doing in this way, in addition to ensuring authenticity of the video image after transcoding, it becomes possible to ensure authenticity of the video image before transcoding, that is, to track the original video image, and also to reduce a processing amount for verification.

### <Configuration Example of Client>

Next, a configuration and an operation of the client 13 illustrated in FIG. 6 will be described.

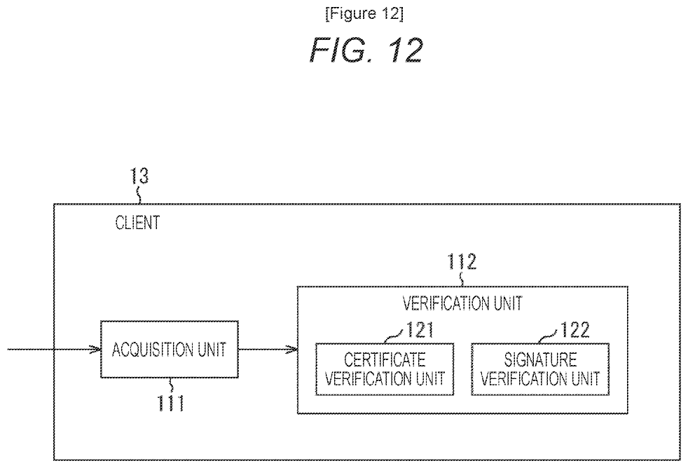

FIG. 12 is a diagram illustrating a configuration example of the client 13.

The client 13 includes, for example, an information processing apparatus such as a computer, and has an acquisition unit 111 and a verification unit 112.

The acquisition unit 111 acquires (receives) the public key certificate Certificate′ [j], the private key K′_{trans_pri}, the video image frame Frame′ [j] [i], and the signature Signature′ [j] [i] output (transmitted) from the output unit 76 of the transcoder 12, and supplies to the verification unit 112.

The verification unit 112 verifies the public key certificate Certificate′ [j] and the signature Signature′ [j] [i] supplied from the acquisition unit 111.

The verification unit 112 has a certificate verification unit 121 that verifies the public key certificate Certificate′ [j], and a signature verification unit 122 that verifies the signature Signature′ [j] [i].

### <Description of Verification Processing>

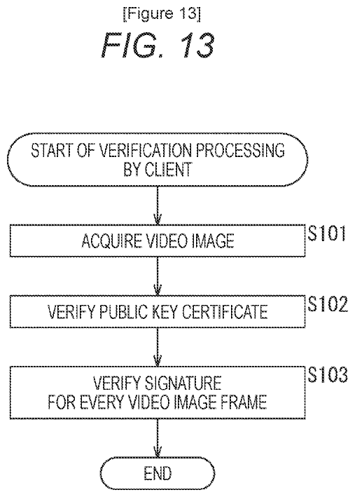

When a video image or the like is transmitted from the transcoder 12, the client 13 starts verification processing. Hereinafter, verification processing performed by the client 13 will be described with reference to a flowchart of FIG. 13.

In step S101, the acquisition unit 111 acquires (receives) the public key certificate Certificate′ [j], the private key K′_{trans_pri}, the video image frame Frame′ [j] [i], and the signature Signature′ [j] [i] transmitted from the transcoder 12, and supplies to the verification unit 112.

In step S102, the certificate verification unit 121 verifies the public key certificate Certificate′ [j] for every time-block supplied from the acquisition unit 111.

That is, for example, the certificate verification unit 121 extracts the public key certificate Certificate [j], the public key K_{transcoder_pub}, the public key K′_{trans_pub}, the signature Sig1′ [j], and the signature Sig2′ [j], from the public key certificate Certificate′ [j]. Furthermore, the certificate verification unit 121 extracts the signature Sig [j] and the signature target data c [j], that is, the public key K_{dev_pub}, session-id [j], the public key K_{trans_pub}, from the public key certificate Certificate [j].

The certificate verification unit 121 verifies the signature Sig [j] for every time-block by performing arithmetic operation of Equation (32) described above, on the basis of the signature target data c [j], the public key K_{dev_pub}, and the signature Sig [j]. Next, the certificate verification unit 121 concatenates the public key certificate Certificate [j], the public key K_{transcoder_pub}, and the public key K′_{trans_pub} according to Equation (34) described above to generate the signature target data c′ [j].

Then, the certificate verification unit 121 verifies the signature Sig1′ [j] for every time-block by performing arithmetic operation of Equation (43) described above, on the basis of the generated signature target data c′ [j], public key K_{transcoder_pub}, and signature Sig1′ [j].

Similarly, the certificate verification unit 121 verifies the signature Sig2′ [j] for every time-block by performing arithmetic operation of Equation (44) described above, on the basis of the generated signature target data c′ [j], public key K_{trans_pub}, and signature Sig2′ [j].

By the verification of the signatures Sig1′ [j] and Sig2′ [j], authenticity of the public key certificate Certificate [j] and the public key certificate Certificate′ [j] is verified, and a relationship between the public key certificate Certificate [j] and the public key certificate Certificate′ [j], that is, a relationship between video images before and after transcoding is also considered to be verified.

Furthermore, the camera 11, which is an output source of the original video image frame Frame [j] [i], is specified from the public key K_{dev_pub}. Further, the transcoder 12, which is an output source of the video image frame Frame′ [j] [i] after transcoding, is also specified from the public key K_{transcoder_pub}.

In step S103, the signature verification unit 122 verifies the signature Signature′ [j] [i] for every video image frame Frame′ [j] [i] supplied from the acquisition unit 111.

That is, the signature verification unit 122 generates the frame position information t [i] for every frame Frame′ [j] [i], by counting the number of frames from the head of the video image supplied from the acquisition unit 111.

Furthermore, the signature verification unit 122 generates the signature target data c′ [j] by concatenating the public key K_{transcoder_pub}, session-id [j], and the public key K′_{trans_pub} that have been extracted by the certificate verification unit 121, according to Equation (39) described above.

The signature verification unit 122 calculates the message m′ [j] [i] by obtaining a hash value of data obtained by concatenating the frame Frame′ [j] [i], the signature target data c′ [j] obtained according to Equation (39), and the frame position information t [i], according to Equation (40) described above on the basis of the hash function SHA-256.

Furthermore, the signature verification unit 122 verifies the signature Signature′ [j] [i] by performing arithmetic operation of Equation (45) described above, on the basis of the message m′ [j] [i] obtained according to Equation (40), the public key K_{transcoder_pub}, and the signature Signature′ [j] [i]. As a result, authenticity of the video image frame Frame′ [j] [i] is considered to be verified on a frame basis of the video image.

When the signature Signature′ [j] [i] is verified, the verification processing ends.

As described above, the client 13 verifies the public key certificate Certificate′ [j] and the signature Signature′ [j] [i] for the video image received from the transcoder 12.

By doing in this way, in addition to verifying authenticity of the video image after transcoding, it becomes possible to verify authenticity of the video image before transcoding, that is, to track the original video image, and also to reduce a processing amount for verification.

### <Configuration Example of Computer>

Note that, the above-described series of processing may be executed by hardware or by software. In a case where a series of processing is executed by the software, a program constituting the software is installed on a computer. Here, examples of the computer include a computer incorporated in dedicated hardware, and for example, a general-purpose personal computer capable of executing various functions by installing various programs.

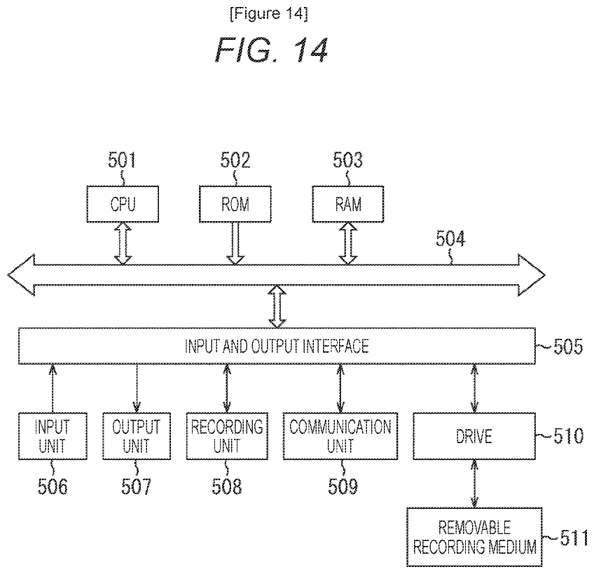

FIG. 14 is a block diagram illustrating a configuration example of hardware of a computer that executes the series of processes described above according to a program.

In the computer, a central processing unit (CPU) 501, a read only memory (ROM) 502, and a random access memory (RAM) 503 are mutually connected by a bus 504.

Moreover, an input and output interface 505 is connected to the bus 504. An input unit 506, an output unit 507, a recording unit 508, a communication unit 509, and a drive 510 are connected to the input and output interface 505.

The input unit 506 includes a keyboard, a mouse, a microphone, an imaging element, and the like. The output unit 507 includes a display, a speaker, and the like. The recording unit 508 includes a hard disk, a non-volatile memory, and the like. The communication unit 509 includes a network interface and the like. The drive 510 drives a removable recording medium 511 such as a magnetic disk, an optical disk, a magneto-optical disk, or a semiconductor memory.

In the computer configured as described above, the CPU 501 loads, for example, a program recorded in the recording unit 508 into the RAM 503 via the input and output interface 505 and the bus 504, and executes the program, so as to perform the above-described series of processing.

A program executed by the computer (CPU 501) can be provided by being recorded on the removable recording medium 511 as a package medium, or the like, for example. Furthermore, the program can be provided via a wired or wireless transmission medium such as a local area network, the Internet, or digital satellite broadcasting.

In the computer, the program can be installed in the recording unit 508 via the input and output interface 505 by mounting the removable recording medium 511 to the drive 510. Furthermore, the program can be received by the communication unit 509 via the wired or wireless transmission medium to be installed on the recording unit 508. In addition, the program can be installed in the ROM 502 or the recording unit 508 in advance.

Note that the program executed by the computer may be a program for processing in time series in the order described in the present description, or a program for processing in parallel or at a necessary timing such as when a call is made.

Furthermore, the embodiment of the present technology is not limited to the above-described embodiment, and various modifications are possible without departing from the scope of the present technology.

For example, the present technology may be configured as cloud computing in which one function is shared by a plurality of apparatuses via the network to process together.

Furthermore, each of the steps in the flowcharts described above can be executed by one apparatus or executed by a plurality of apparatuses in a shared manner.

Moreover, in a case where a plurality of processing is included in one step, the plurality of processing included in one step can be executed by one apparatus or by a plurality of apparatuses in a shared manner.

Moreover, the present technology may also have a following configuration.
(1)
An information processing apparatus including:
a signature generation unit configured to generate a first signature for every frame, on the basis of identification information, the frame of a video image, and a first private key of public key cryptosystem, the identification information being assigned to a time-block including a plurality of the frames of the video image;
a certificate generation unit configured to generate a certificate including the identification information; and
an output unit configured to output the certificate, the video image, and the first signature.
(2)
The information processing apparatus according to (1), in which
the signature generation unit generates the first signature on the basis of: a first public key corresponding to the first private key; the identification information; the frame; and the first private key.
(3)
The information processing apparatus according to (1) or (2), in which
the signature generation unit generates the first signature on the basis of: position information indicating a position of the frame in the video image; the identification information; the frame; and the first private key.
(4)
The information processing apparatus according to (2), in which
the signature generation unit generates the first signature on the basis of: a second public key corresponding to a second private key of public key cryptosystem, the second private key being generated for the video image; the first public key; the identification information; the frame; and the first private key, the certificate generation unit generates the certificate, the certificate including the identification information and the second public key, and
the output unit outputs the certificate, the second private key, the video image, and the first signature.
(5)
The information processing apparatus according to (4), in which
the certificate generation unit generates the certificate for the every time-block.
(6)
The information processing apparatus according to (5), in which
the certificate generation unit
generates a second signature for the every time-block, on the basis of the first public key, the second public key, and the first private key; and
generates the certificate, the certificate including the second signature, the identification information, and the second public key.
(7)
The information processing apparatus according to (6), in which
in a case where the video image is generated by transcoding on an original video image,
the certificate generation unit
generates the second signature on the basis of: the certificate of the original video image, the certificate including the identification information; the first public key; the second public key; and the first private key; and
generates a third signature on the basis of the certificate of the original video image, the first public key, the second public key, and the second private key of the original video image, and
generates the certificate, the certificate including the certificate of the original video image, the second signature, the third signature, and the second public key.
(8)
An information processing method for an information processing apparatus to perform:
generating a signature for every frame, on the basis of identification information, the frame of a video image, and a private key of public key cryptosystem, the identification information being assigned to a time-block including a plurality of the frames of the video image;
generating a certificate including the identification information; and
outputting the certificate, the video image, and the signature.
(9)
A program for causing a computer to execute processing including steps of:
generating a signature for every frame, on the basis of identification information, the frame of a video image, and a private key of public key cryptosystem, the identification information being assigned to a time-block including a plurality of the frames of the video image;
generating a certificate including the identification information; and
outputting the certificate, the video image, and
the signature.
(10)
An information processing apparatus including:
an acquisition unit configured to acquire a certificate for every time-block, a video image, and a first signature for every frame, the certificate including identification information assigned to the time-block including a plurality of the frames of the video image, and the first signature being generated on the basis of the identification information, the frame of the video image, a first public key corresponding to a first private key of public key cryptosystem, and the first private key; and
a signature verification unit configured to verify the first signature on the basis of the certificate, the video image, and the first public key.
(11)
The information processing apparatus according to (10), in which
the first signature is generated on the basis of: position information indicating a position of the frame in the video image; the identification information; the frame of the video image; the first public key; and the first private key.
(12)
The information processing apparatus according to (10) or (11), in which
the first signature is generated on the basis of: a second public key corresponding to a second private key of public key cryptosystem, the second private key being generated for the video image; the identification information; the frame of the video image; the first public key; and the first private key,
the certificate includes the identification information and the second public key, and
the acquisition unit acquires the certificate, the second private key, the video image, and the first signature.
(13)
The information processing apparatus according to (12), in which
the certificate includes a second signature generated on the basis of the first public key, the second public key, and the first private key, and
the information processing apparatus further includes a certificate verification unit configured to verify the second signature on the basis of the first public key and the second public key.
(14)
The information processing apparatus according to (13), in which
in a case where the video image is generated by transcoding on an original video image,
the certificate includes:
the certificate of the original video image, the certificate including the identification information and the second public key of the original video image;
the second public key;
the second signature generated on the basis of the certificate of the original video image, the first public key, the second public key, and the first private key; and
a third signature generated on the basis of the certificate of the original video image, the first public key, the second public key, and the second private key of the original video image, and
the certificate verification unit verifies the third signature on the basis of the certificate of the original video image, the first public key, and the second public key.
(15)
An information processing method for an information processing apparatus to perform:
acquiring a certificate for every time-block, a video image, and a signature for every frame, the certificate including identification information assigned to the time-block including a plurality of the frames of the video image, and the signature being generated on the basis of the identification information, the frame of the video image, a public key corresponding to a private key of public key cryptosystem, and the private key, and
verifying the signature on the basis of the certificate, the video image, and the public key.
(16)
A program for causing a computer to execute processing including steps of:
acquiring a certificate for every time-block, a video image, and a signature for every frame, the certificate including identification information assigned to the time-block including a plurality of the frames of the video image, and the signature being generated on the basis of the identification information, the frame of the video image, a public key corresponding to a private key of public key cryptosystem, and the private key, and
verifying the signature on the basis of the certificate, the video image, and the public key.

### REFERENCE SIGNS LIST

11 Camera
12 Transcoder
13 Client
42 Certificate generation unit
43 Signature generation unit
44 Output unit
74 Certificate generation unit
75 Signature generation unit
76 Output unit
81 Certificate verification unit
82 Signature verification unit
111 Acquisition unit
121 Certificate verification unit
122 Signature verification unit

1. An information processing apparatus comprising:
a signature generation unit configured to generate a first signature for every frame on a basis of identification information, the frame of a video image, and a first private key of public key cryptosystem, the identification information being assigned to a time-block including a plurality of the frames of the video image;
a certificate generation unit configured to generate a certificate including the identification information; and
an output unit configured to output the certificate, the video image, and the first signature.

2. The information processing apparatus according to claim 1, wherein
the signature generation unit generates the first signature on a basis of: a first public key corresponding to the first private key; the identification information; the frame; and the first private key.

3. The information processing apparatus according to claim 1, wherein
the signature generation unit generates the first signature on a basis of: position information indicating a position of the frame in the video image; the identification information; the frame; and the first private key.

4. The information processing apparatus according to claim 2, wherein
the signature generation unit generates the first signature on a basis of: a second public key corresponding to a second private key of public key cryptosystem, the second private key being generated for the video image; the first public key; the identification information; the frame; and the first private key,
the certificate generation unit generates the certificate, the certificate including the identification information and the second public key, and
the output unit outputs the certificate, the second private key, the video image, and the first signature.

5. The information processing apparatus according to claim 4, wherein
the certificate generation unit generates the certificate for the every time-block.

6. The information processing apparatus according to claim 5, wherein
the certificate generation unit
generates a second signature for the every time-block, on a basis of the first public key, the second public key, and the first private key; and
generates the certificate, the certificate including the second signature, the identification information, and the second public key.

7. The information processing apparatus according to claim 6, wherein
in a case where the video image is generated by transcoding on an original video image,
the certificate generation unit
generates the second signature on a basis of: the certificate of the original video image, the certificate including the identification information; the first public key; the second public key; and the first private key; and
generates a third signature on a basis of the certificate of the original video image, the first public key, the second public key, and the second private key of the original video image, and
generates the certificate, the certificate including the certificate of the original video image, the second signature, the third signature, and the second public key.

8. An information processing method for an information processing apparatus to perform:
generating a signature for every frame on a basis of identification information, the frame of a video image, and a private key of public key cryptosystem, the identification information being assigned to a time-block including a plurality of the frames of the video image;
generating a certificate including the identification information; and
outputting the certificate, the video image, and the signature.

9. A program for causing a computer to execute processing including steps of:
generating a signature for every frame on a basis of identification information, the frame of a video image, and a private key of public key cryptosystem, the identification information being assigned to a time-block including a plurality of the frames of the video image;
generating a certificate including the identification information; and
outputting the certificate, the video image, and the signature.

10. An information processing apparatus comprising:
an acquisition unit configured to acquire a certificate for every time-block, a video image, and a first signature for every frame, the certificate including identification information assigned to the time-block including a plurality of the frames of the video image, and the first signature being generated on a basis of the identification information, the frame of the video image, a first public key corresponding to a first private key of public key cryptosystem, and the first private key; and
a signature verification unit configured to verify the first signature on a basis of the certificate, the video image, and the first public key.

11. The information processing apparatus according to claim 10, wherein
the first signature is generated on a basis of: position information indicating a position of the frame in the video image; the identification information; the frame of the video image; the first public key; and the first private key.

12. The information processing apparatus according to claim 10, wherein
the first signature is generated on a basis of: a second public key corresponding to a second private key of public key cryptosystem, the second private key being generated for the video image; the identification information; the frame of the video image; the first public key; and the first private key, and
the certificate includes the identification information and the second public key, and
the acquisition unit acquires the certificate, the second private key, the video image, and the first signature.

13. The information processing apparatus according to claim 12, wherein
the certificate includes a second signature generated on a basis of the first public key, the second public key, and the first private key, and
the information processing apparatus further includes a certificate verification unit configured to verify the second signature on a basis of the first public key and the second public key.

14. The information processing apparatus according to claim 13, wherein
in a case where the video image is generated by transcoding on an original video image,
the certificate includes:
the certificate of the original video image, the certificate including the identification information and the second public key of the original video image;
the second public key;
the second signature generated on a basis of the certificate of the original video image, the first public key, the second public key, and the first private key; and
a third signature generated on a basis of the certificate of the original video image, the first public key, the second public key, and the second private key of the original video image, and
the certificate verification unit verifies the third signature on a basis of the certificate of the original video image, the first public key, and the second public key.

15. An information processing method for an information processing apparatus to perform:
acquiring a certificate for every time-block, a video image, and a signature for every frame, the certificate including identification information assigned to the time-block including a plurality of the frames of the video image, and the signature being generated on a basis of the identification information, the frame of the video image, a public key corresponding to a private key of public key cryptosystem, and the private key, and
verifying the signature on a basis of the certificate, the video image, and the public key.

16. A program for causing a computer to execute processing including steps of:
acquiring a certificate for every time-block, a video image, and a signature for every frame, the certificate including identification information assigned to the time-block including a plurality of the frames of the video image, and the signature being generated on a basis of the identification information, the frame of the video image, a public key corresponding to a private key of public key cryptosystem, and the private key, and
verifying the signature on a basis of the certificate, the video image, and the public key.
